(19) United States
(12) Patent Application Publication
(10) Pub. No.: US 2007/0082877 A1
(43) Pub. Date: Apr. 12, 2007

(54) Difluoromethylbenzanilides and use thereof for combating micro-organisms, intermediate products and use thereof

(75) Inventors: Ralf Dunkel, Lyon (FR); Hans Ludwig Elbe, Wuppertal (DE); Jorg Nico Greul, Leichlingen (DE); Benoit Hartmann, Langenfeld (DE); Ulrike Wachendorff-Neumann, Neuwied (DE); Peter Dahmen, Neuss (DE); Karl-Heinz Kuck, Langenfeld (DE); Heiko Rieck, Foy les Lyon (FR)

Correspondence Address: STERNE, KESSLER, GOLDSTEIN & FOX P.L.L.C., 1100 NEW YORK AVENUE, N.W., WASHINGTON, DC, 20005, US

(73) Assignee: BAYER CORPSCIENCE AKTIENGESELLSCHAFT, Monheim (DE)

(21) Appl. No.: 10/557,054

(22) PCT Filed: May 12, 2004
(86) PCT No.: PCT/EP04/05067

§ 371 Date: Nov. 29, 2006

(30) Foreign Application Priority Data
May 21, 2003 (DE) 10322909.4

(51) Int. Cl. A01N 37/18; A01N 43/00; A01N 43/40; A01N 43/36

(52) U.S. Cl. 514/183; 514/617; 514/212.01; 514/317; 514/408; 546/229; 548/577; 564/184; 540/611

(57) ABSTRACT

Novel difluoromethylbenzanilides of the formula (I) 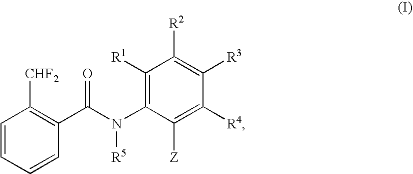 in which
R¹, R², R³, R⁴, R⁵ and Z are as defined in the description, a plurality of processes for preparing these compounds and their use for controlling unwanted microorganisms, and also novel intermediates and their preparation.

The present invention relates to novel difluoromethylbenzanilides, to a plurality of processes for their preparation and to their use for controlling unwanted microorganisms.

It is already known that numerous carboxanilides have fungicidal properties (cf. EP-A 0 545 099, JP-A 2001-302605, JP-A 8-176112). Thus, N-4′-fluoro-1,1′-biphenyl-2-yl)-2-(trifluoromethyl)benzamide und N-(2-sec-butylphenyl)2-(trifluoromethyl)benzamide are already known from EP-A 0 554 099. The activity of these compounds is good; however, in some cases, for example at low application rates, it is unsatisfactory. Difluoromethylbenzanilides have hitherto not been disclosed.

This invention now provides novel difluoromethylbenzanilides of the formula (I) 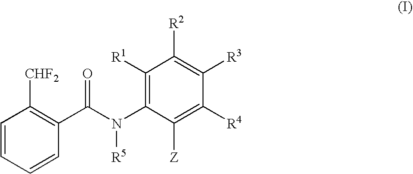
in which
R¹, R², R³ and R⁴ independently of one another represent hydrogen, fluorine, chlorine, methyl, isopropyl or methylthio,
R⁵ represents hydrogen, C₁-C₈-alkyl, C₁-C₆-alkylsulphinyl, C₁-C₆-alkylsulphonyl, C₁-C₄-alkoxy-C₁-C₄-alkyl, C₃-C₈-cycloalkyl; C₁-C₆-haloalkyl, C₁-C₄-haloalkylthio, C₁-C₄-haloalkylsulphinyl, C₁-C₄-haloalkylsulphonyl, halo-C₁-C₄-alkoxy-C₁-C₄-alkyl, C₃-C₈-halocycloalkyl having in each case 1 to 9 fluorine, chlorine and/or bromine atoms, formyl-C₁-C₃-alkyl, (C₁-C₃-alkyl)carbonyl-C₁-C₃-alkyl, (C₁-C₃-alkoxy)carbonyl-C₁-C₃-alkyl; (C₁-C₃-haloalkyl)carbonyl-C₁-C₃-alkyl, (C₁-C₃-haloalkoxy)carbonyl-C₁-C₃-alkyl having in each case 1 to 7 fluorine, chlorine and/or bromine atoms, (C₁-C₃-alkyl)carbonyl-C₁-C₃-haloalkyl, (C₁-C₃-alkoxy)carbonyl-C₁-C₃-haloalkyl having in each case 1 to 6 fluorine, chlorine and/or bromine atoms, (C₁-C₃-haloalkyl)carbonyl-C₁-C₃-haloalkyl, (C₁-C₃-haloalkoxy)carbonyl-C₁-C₃-haloalkyl having in each case 1 to 13 fluorine, chlorine and/or bromine atoms; —COR⁶, —CONR⁷R⁸ or —CH₂NR⁹R¹⁰,
R⁶ represents hydrogen, C₁-C₈-alkyl, C₁-C₈-alkoxy, C₁-C₄-alkoxy-C₁-C₄-alkyl, C₃-C₈-cycloalkyl; C₁-C₆-haloalkyl, C₁-C₆-haloalkoxy, halo-C₁-C₄-alkoxy-C₁-C₄-alkyl, C₃-C₈-halocycloalkyl having in each case 1 to 9 fluorine, chlorine and/or bromine atoms, —COR¹¹,
R⁷ and R⁸ independently of one another represent hydrogen, C₁-C₈-alkyl, C₁-C₄-alkoxy-C₁-C₄-alkyl, C₃-C₈-Cycloalkyl; C₁-C₈haloalkyl, halo-C₁-C₄-alkoxy-C₁-C₄-alkyl, C₃-C₈-halocycloalkyl having in each case 1 to 9 fluorine, chlorine and/or bromine atoms,
R⁷ and R⁸ furthermore together with the nitrogen atom to which they are attached form a saturated heterocycle which is optionally mono-or polysubstituted by identical or different substituents from the group consisting of halogen and C₁-C₄-alkyl and which has 5 to 8 ring atoms, where the heterocycle may contain 1 or 2 further non-adjacent heteroatoms from the group consisting of oxygen, sulphur and NR¹²,
R⁹ and R¹⁰ independently of one another represent hydrogen, C₁-C₈-alkyl, C₃-C₈-cycloalkyl; C₁-C₈-haloalkyl, C₃-C₈-halocycloalkyl having in each case 1 to 9 fluorine, chlorine and/or bromine atoms,
R⁹ and R¹⁰ furthermore together with the nitrogen atom to which they are attached form a saturated heterocycle which is optionally mono-or polysubstituted by identical or different substituents from the group consisting of halogen and C₁-C₄-alkyl and which has 5 to 8 ring atoms, where the heterocycle may contain one or two further non-adjacent heteroatoms from the group consisting of oxygen, sulphur and NR¹²,
R¹¹ represents hydrogen, C₁-C₈-alkyl, C₁-C₈-alkoxy, C₁-C₄-alkoxy-C₁-C₄-alkyl, C₃-C₈-cycloalkyl; C₁-C₆-haloalkyl, C₁-C₆-haloalkoxy, halo-C₁-C₄-alkoxy-C₁-C₄-alkyl, C₃-C₈-halocycloalkyl having in each case 1 to 9 fluorine, chlorine and/or bromine atoms,
R¹² represents hydrogen or C₁-C₆-alkyl,
Z represents Z¹, Z², Z³ or Z⁴, where
Z¹ represents phenyl which is optionally mono- to pentasubstituted by identical or different substituents,
Z² represents bicycloalkyl or cycloalkyl which is optionally mono- or polysubstituted by identical or different substituents,
Z³ represents unsubstituted C₂-C₂₀-alkyl or represents C₁-C₂₀-alkyl which is mono- or polysubstituted by identical or different substituents from the group consisting of halogen and C₃-C₆-cycloalkyl, where the cycloalkyl moiety for its part may optionally be mono- or polysubstituted by identical or different substituents from the group consisting of halogen and C₁-C₄-alkyl,
Z⁴ represents C₂-C₂₀-alkenyl or C₂-C₂₀-alkynyl, each of which is optionally mono- or polysubstituted by identical or different substituents from the group consisting of halogen and C₃-C₆-cycloalkyl, where the cycloalkyl moiety for its part may optionally be mono- or polysubstituted by identical or different substituents from the group consisting of halogen and C₁-C₄-alkyl,
   or
R¹, R² and R³ independently of one another represent hydrogen or fluorine and
Z and R⁴ together with the carbon atoms to which they are attached form an optionally substituted 5- or 6-membered carbocyclic or heterocyclic ring.

Furthermore, it has been found that difluoromethylbenzanilides of the formula (I) are obtained when
a) difluoromethylbenzoyl derivatives of the formula (II) 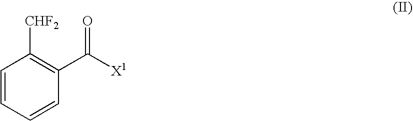
   in which
   X¹ represents chlorine or hydroxyl,
   are reacted with aniline derivatives of the formula (III) 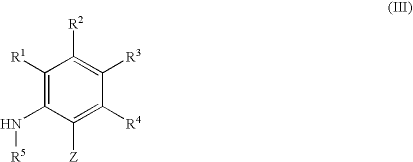
   in which R¹, R², R³, R⁴, R⁵ and Z are as defined above,
   if appropriate in the presence of a catalyst, if appropriate in the presence of a condensing agent, if appropriate in the presence of an acid binder and if appropriate in the presence of a diluent,
      or
b) halodifluoromethylbenzanilides of the formula (IV) 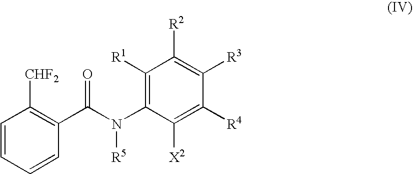
   in which
   R¹, R², R³, R⁴ and R⁵ are as defined above and
   X² represents chlorine, bromine, iodine or trifluoromethylsulphonate are reacted with boronic acid derivatives of the formula (V) 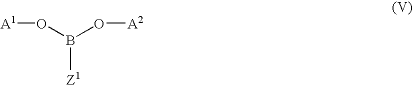
   in which
   Z¹ is as defined above and
   A¹ and A² each represent hydrogen or together represent tetramethylethylene, in the presence of a catalyst, if appropriate in the presence of an acid binder and if appropriate in the presence of a diluent,
      or
c) difluoromethylbenzamide boronic acid derivatives of the formula (VI) 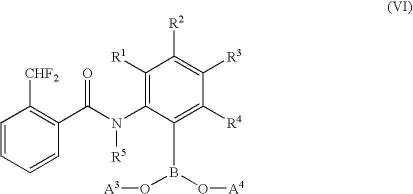
   in which
   R¹, R², R³, R⁴ and R⁵ are as defined above and
   A³ and A⁴ each represent hydrogen or together represent tetramethylethylene, are reacted with phenyl derivatives of the formula (VII)
      X³-Z¹ (VII)
   in which
   Z¹ is as defined above and
   X³ represents chlorine, bromine, iodine or trifluoromethylsulphonate, in the presence of a catalyst, if appropriate in the presence of an acid binder and if appropriate in the presence of a diluent,
      or
d) halodifluoromethylbenzanilides of the formula (IV) 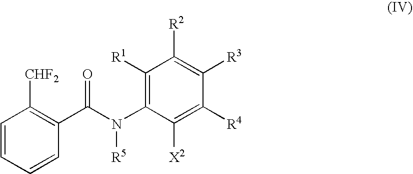
   in which
   R¹, R², R³, R⁴ and R⁵ are as defined above, and
   X² represents chlorine, bromine, iodine or trifluoromethylsulphonate, are reacted with phenyl derivatives of the formula (VII)
      X³-Z¹ (VII)
   in which
   Z¹ is as defined above and
   X³ represents chlorine, bromine, iodine or trifluoromethylsulphonate, in the presence of a palladium or nickel catalyst and in the presence of 4,4,4′,4′,5,5,5′,5′-octamethyl-2,2′-bis-1,3,2-dioxaborolane, if appropriate in the presence of an acid binder and if appropriate in the presence of a diluent,
      or
e) difluoromethylbenzanilides of the formula (Ia) 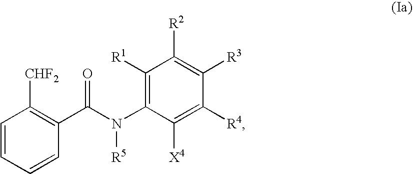
   in which
   R¹, R², R³, R⁴ and R⁵ are as defined above and
   X⁴ represents C₂-C₂₀-alkenyl or C₂-C₂₀-alkynyl, each of which is optionally mono- or polysubstituted by identical or different substituents from the group consisting of halogen and C₃-C₆-cycloalkyl, where the cycloalkyl moiety for its part may optionally be substituted by halogen and/or C₁-C₄-alkyl,
   are hydrogenated, if appropriate in the presence of a diluent and if appropriate in the presence of a catalyst,
      or
f) hydroxyalkyldifluoromethylbenzanilides of the formula (VIII) 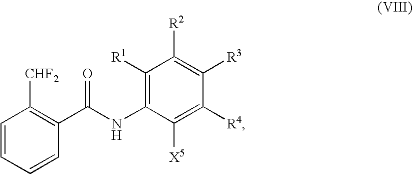
   in which
   R¹, R², R³, R⁴ and R⁵ are as defined above and
   X⁵ represents C₂-C₂₀-hydroxyalkyl which is optionally additionally mono- or polysubstituted by identical or different substituents from the group consisting of halogen and C₃-C₆-cycloalkyl, where the cycloalkyl moiety for its part may optionally be substituted by halogen and/or C₁-C₄-alkyl,
   are dehydrated, if appropriate in the presence of a diluent and if appropriate in the presence of an acid,
      or
g) halogen-difluormethylbenzanilides of the formula (IV) 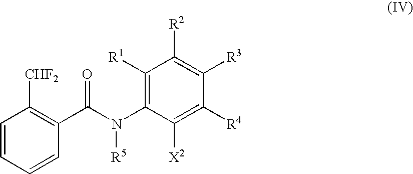
   in which
   R¹, R², R³, R⁴ and R⁵ are as defined above, and
   X² represents chlorine, bromine, iodine or trifluoromethylsulphonate, are reacted with an alkine of the formula (IX)
      HC≡-A⁵ (IX),
   in which
   A⁵ represents C₂-C₁₈-alkyl which is optionally mono- or polysubstituted by identical or different substituents from the group consisting of halogen and C₃-C₆-cycloalkyl, where the cycloalkyl moiety for its part may optionally be substituted by halogen and/or C₁-C₄-alkyl,
   or an alkene of the formula (X) 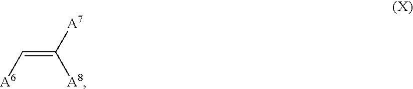
   in which
   A⁶, A⁷ and A⁸ independently of one another each represent hydrogen or alkyl which is optionally mono- or polysubstituted by identical or different substituents from the group consisting of halogen and C₃-C₆-cycloalkyl, where the cycloalkyl moiety for its part may optionally be substituted by halogen and/or C₁-C₄-alkyl and the total number of carbon atoms of the open-chain part of the molecule does not exceed the number 20,
   if appropriate in the presence of a diluent, if appropriate in the presence of an acid binder and
   if appropriate in the presence of one or more catalysts,
      or
h) ketones of the formula (XI) 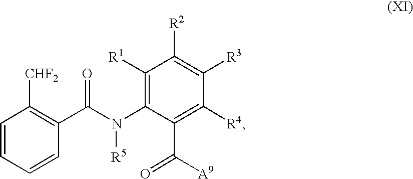
   in which
   R¹, R², R³, R⁴ and R⁵ are as defined above and
   A⁹ represents hydrogen or represents C₁-C₁₈-alkyl which is optionally mono- or polysubstituted by identical or different substituents from the group consisting of halogen and C₃-C₆-cycloalkyl, where the cycloalkyl moiety for its part may optionally be substituted by halogen and/or C₁-C₄-alkyl,
   are reacted with a phosphorus compound of the formula (XII)
      A¹⁰-Px (XII),
   in which
   A¹⁰ represents C₁-C₁₈-alkyl which is optionally mono- or polysubstituted by identical or different substituents from the group consisting of halogen and C₃-C₆-cycloalkyl, where the cycloalkyl moiety for its part may optionally be substituted by halogen and/or C₁-C₄-alkyl,
   Px represents a grouping —P⁺(C₆H₅)₃Cl⁻, —P⁺(C₆H₅)₃Br⁻, —P⁺(C₆H₅)₃I⁻, —P(═O)(OCH₃)₃ or —P(═O)(OC₂H₅)₃,
   if appropriate in the presence of a diluent,
      or
i) difluoromethylbenzanilides of the formula (Ib) 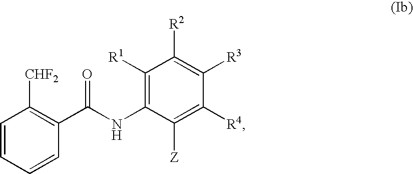
   in which
   R¹, R², R³, R⁴ and Z are as defined above
   are reacted with a halide of the formula (XIII)
      R⁵⁻¹—X⁶ (XIII)
   in which
   R⁵⁻¹ represents C₁-C₈-alkyl, C₁-C₆-alkylsulphinyl, C₁-C₆-alkylsulphonyl, C₁-C₄-alkoxy-C₁-C₄-alkyl, C₃-C₈-cycloalkyl; C₁-C₆-haloalkyl, C₁-C₄-haloalkylthio, C₁-C₄-haloalkylsulphinyl, C₁-C₄-haloalkylsulphonyl, halo-C₁-C₄-alkoxy-C₁-C₄-alkyl, C₃-C₈-halocycloalkyl having in each case 1 to 9 fluorine, chlorine and/or bromine atoms, formyl-C₁-C₃-alkyl, (C₁-C₃-alkyl)carbonyl-C₁-C₃-alkyl, (C₁-C₃-alkoxy)carbonyl-C₁-C₃-alkyl; (C₁-C₃-haloalkyl)carbonyl-C₁-C₃-alkyl, (C₁-C₃-haloalkoxy)carbonyl-C₁-C₃-alkyl having in each case 1 to 7 fluorine, chlorine and/or bromine atoms, (C₁-C₃-alkyl)carbonyl-C₁-C₃-haloalkyl, (C₁-C₃-alkoxy)carbonyl-C₁-C₃-haloalkyl having in each case 1 to 6 fluorine, chlorine and/or bromine atoms, (C₁-C₃-haloalkyl)carbonyl-C₁-C₃-haloalkyl, (C₁-C₃-haloalkoxy)carbonyl-C₁-C₃-haloalkyl having in each case 1 to 13 fluorine, chlorine and/or bromine atoms; —COR⁶, —CONR⁷R⁸ or —CH₂NR⁹R¹⁰,
   R⁶, R⁷, R⁸, R⁹ and R¹⁰ are as defined above and
   X⁶ represents chlorine, bromine or iodine,
   in the presence of a base and in the presence of a diluent.

Finally, it has been found that the novel difluoromethylbenzanilides of the formula (I) have very good microbicidal properties and can be used for controlling unwanted microorganisms both in crop protection and in the protection of materials.

Surprisingly, the difluoromethylbenzanilides of the formula (I) according to the invention have considerably better fungicidal activity than the constitutionally most similar active compounds of the prior art having the same direction of action.

If appropriate, the compounds according to the invention can be present as mixtures of different possible isomeric forms, and in particular of stereoisomers, such as, for example, E and Z, threo and erythro and also optical isomers, and, if appropriate, also of tautomers. What is claimed are both the E and the Z isomers, and the threo and erythro and also the optical isomers, and mixtures of these isomers, and the possible tautomeric forms.

The formula (I) provides a general definition of the difluoromethylbenzanilides according to the invention. Preferred radical definitions of the formulae mentioned above and below are given below. These definitions apply both to the end products of the formula (I) and, correspondingly, to all intermediates.
R¹, R², R³ and R⁴ independently of one another preferably represent hydrogen, fluorine, chlorine or methyl.
R¹ particularly preferably represents hydrogen or fluorine.
R¹ very particularly preferably represents hydrogen.
R¹ also very particularly preferably represents fluorine.
R² particularly preferably represents hydrogen.
R³ particularly preferably represents hydrogen, fluorine, chlorine or methylthio.
R³ very particularly preferably represents hydrogen.
R³ also very particularly preferably represents fluorine.
R⁴ particularly preferably represents hydrogen, methyl or isopropyl.
R⁴ very particularly preferably represents hydrogen.
R⁴ also very particularly preferably represents methyl.
R¹, R², R³ and R⁴ very particularly preferably all represent hydrogen.
R⁵ preferably represents hydrogen; C₁-C₆-alkyl, C₁-C₄-alkylsulphinyl, C₁-C₄-alkylsulphonyl, C₁-C₃-alkoxy-C₁-C₃-alkyl, C₃-C₆-cycloalkyl; C₁-C₄-haloalkyl, C₁-C₄-haloalkylthio, C₁-C₄-haloalkylsulphinyl, C₁-C₄-haloalkylsulphonyl, halo-C₁-C₃-alkoxy-C₁-C₃-alkyl, C₃-C₆-halocycloalkyl having in each case 1 to 9 fluorine, chlorine and/or bromine atoms, formyl-C₁-C₃-alkyl, (C₁-C₃-alkyl)carbonyl-C₁-C₃-alkyl, (C₁-C₃-alkoxy)carbonyl-C₁-C₃-alkyl; (C₁-C₃-haloalkyl)carbonyl-C₁-C₃-alkyl, (C₁-C₃-haloalkoxy)carbonyl-C₁-C₃-alkyl having in each case 1 to 7 fluorine, chlorine and/or bromine atoms, (C₁-C₃-alkyl)carbonyl-C₁-C₃-haloalkyl, (C₁-C₃-alkoxy)carbonyl-C₁-C₃-haloalkyl having in each case 1 to 6 fluorine, chlorine and/or bromine atoms, (C₁-C₃-haloalkyl)carbonyl-C₁-C₃-haloalkyl, (C₁-C₃-haloalkoxy)carbonyl-C₁-C₃-haloalkyl having in each case 1 to 13 fluorine, chlorine and/or bromine atoms; —COR⁶, —CONR⁷R⁸ or —CH₂NR⁹R¹⁰.
R⁵ particularly preferably represents hydrogen, methyl, ethyl, n- or isopropyl, n-, iso-, sec- or tert-butyl, pentyl or hexyl, methylsulphinyl, ethylsulphinyl, n- or isopropylsulphinyl, n-, iso-, sec- or tert-butylsulphinyl, methylsulphonyl, ethylsulphonyl, n- or iso-propylsulphonyl, n-, iso-, sec- or tert-butylsulphonyl, methoxymethyl, methoxyethyl, ethoxymethyl, ethoxyethyl, cyclopropyl, cyclopentyl, cyclohexyl, trifluoromethyl, trichloromethyl, trifluoroethyl, difluoromethylthio, difluorochloromethylthio, trifluoromethylthio, trifluoromethylsulphinyl, trifluoromethylsulphonyl, trifluoromethoxymethyl, —CH₂—CHO, —CH₂CH₂—CHO, —CH₂—CO—CH₃, —CH₂—CO—CH₂CH₃, —CH₂—CO—CH(CH₃)₂, —CH₂CH₂—CO—CH₃, —CH₂CH₂—CO—CH₂CH₃, —CH₂CH₂—CO—CH(CH₃)₂, —CH₂—C(O)OCH₃, —CH₂—C(O)OCH₂CH₃, —CH₂—C(O)OCH(CH₃)₂, —CH₂CH₂—C(O)OCH₃, —CH₂CH₂—C(O)OCH₂CH₃, —CH₂CH₂—C(O)OCH(CH₃)₂, —CH₂—CO—CF₃, —CH₂—CO—CCl₃, —CH₂—CO—CH₂CF₃, —CH₂—CO—CH₂CCl₃, —CH₂CH₂—CO—CH₂CF₃, —CH₂CH₂—CO—CH₂CCl₃, —CH₂—C(O)OCH₂CF₃, —CH₂—C(O)OCF₂CF₃, —CH₂—C(O)OCH₂CCl₃, —CH₂—C(O)OCCl₂CCl₃, —CH₂CH₂—C(O)OCH₂CF₃, —CH₂CH₂—C(O)OCF₂CF₃, —CH₂CH₂—C(O)OCH₂CCl₃, —CH₂CH₂—C(O)O—CCl₂CCl₃; —COR⁶, —CONR⁷R⁸ or —CH₂NR⁹R¹⁰.
R⁵ very particularly preferably represents hydrogen; methyl, methoxymethyl, —CH₂—CHO, —CH₂CH₂—CHO, —CH₂—CO—CH₃, —CH₂—CO—CH₂CH₃, —CH₂—CO—CH(CH₃)₂ or —COR⁶.
R⁶ preferably represents hydrogen, C₁-C₆-alkyl, C₁-C₄-alkoxy, C₁-C₃-alkoxy-C₁-C₃-alkyl, C₃-C₆-cycloalkyl; C₁-C₄-haloalkyl, C₁-C₄-haloalkoxy, halo-C₁-C₃-alkoxy-C₁-C₃-alkyl, C₃-C₆-halocycloalkyl having in each case 1 to 9 fluorine, chlorine and/or bromine atoms, —COR¹¹.
R⁶ particularly preferably represents hydrogen, methyl, ethyl, n- or isopropyl, tert-butyl, methoxy, ethoxy, isopropoxy, tert-butoxy, cyclopropyl; trifluoromethyl, trifluoromethoxy, —COR¹¹.
R⁶ very particularly preferably represents hydrogen, —COCH₃, —CHO, —COCH₂OCH₃, —COCO₂CH₃, —COCO₂CH₂CH₃.
R⁷ and R⁸ independently of one another preferably represent hydrogen, C₁-C₆-alkyl, C₁-C₃-alkoxy-C₁-C₃-alkyl, C₃-C₆-cycloalkyl; C₁-C₄-haloalkyl, halo-C₁-C₃-alkoxy-C₁-C₃-alkyl, C₃-C₆-halocycloalkyl having in each case 1 to 9 fluorine, chlorine and/or bromine atoms.
R⁷ and R⁸ furthermore together with the nitrogen atom to which they are attached preferably form a saturated heterocycle which is optionally mono- to tetrasubstituted by identical or different substituents from the group consisting of halogen and C₁-C₄-alkyl and which has 5 to 8 ring atoms, where the heterocycle may contain 1 or 2 further non-adjacent heteroatoms from the group consisting of oxygen, sulphur and NR¹².
R⁷ and R⁸ independently of one another particularly preferably represent hydrogen, methyl, ethyl, n-or isopropyl, n-, iso-, sec- or tert-butyl, methoxymethyl, methoxyethyl, ethoxymethyl, ethoxyethyl, cyclopropyl, cyclopentyl, cyclohexyl; trifluoromethyl, trichloromethyl, trifluoroethyl, trifluoromethoxymethyl.
R⁷ and R⁸ furthermore together with the nitrogen atom to which they are attached particularly preferably form a saturated heterocycle from the group consisting of morpholine, thiomorpholine and piperazine, where the piperazine may be substituted at the second nitrogen atom by R¹², which heterocycle is optionally mono- to tetrasubstituted by identical or different substituents from the group consisting of fluorine, chlorine, bromine and methyl.
R⁹ and R¹⁰ independently of one another preferably represent hydrogen, C₁-C₆-alkyl, C₃-C₆-cycloalkyl; C₁-C₄-haloalkyl, C₃-C₆-halocycloalkyl having in each case 1 to 9 fluorine, chlorine and/or bromine atoms.
R⁹ and R¹⁰ furthermore together with the nitrogen atom to which they are attached preferably form a saturated heterocycle which is optionally mono- or polysubstituted by identical or different substituents from the group consisting of halogen and C₁-C₄-alkyl and which has 5 to 8 ring atoms, where the heterocycle may contain 1 or 2 further non-adjacent heteroatoms from the group consisting of oxygen, sulphur and NR¹².
R⁹ and R¹⁰ independently of one another particularly preferably represent hydrogen, methyl, ethyl, n- or isopropyl, n-, iso-, sec- or tert-butyl, methoxymethyl, methoxyethyl, ethoxymethyl, ethoxyethyl, cyclopropyl, cyclopentyl, cyclohexyl; trifluoromethyl, trichloromethyl, trifluoroethyl, trifluoromethoxymethyl.
R⁹ and R¹⁰ furthermore together with the nitrogen atom to which they are attached particularly preferably form a saturated heterocycle from the group consisting of morpholine, thiomorpholine and piperazine, where the piperazine may be substituted at the second nitrogen atom by R¹², which heterocycle is optionally mono to tetrasubstituted by identical or different substituents from the group consisting of fluorine, chlorine, bromine and methyl.
R¹¹ preferably represents hydrogen, C₁-C₆-alkyl, C₁-C₄-alkoxy, C₁-C₃-alkoxy-C-C₃-alkyl, C₃-C₆-cycloalkyl; C₁-C₄-haloalkyl, C₁-C₄-haloalkoxy, halo-C₁-C₃-alkoxy-C₁-C₃-alkyl, C₃-C₆-halocycloalkyl having in each case 1 to 9 fluorine, chlorine and/or bromine atoms.
R¹¹ particularly preferably represents hydrogen, methyl, ethyl, n- or isopropyl, tert-butyl, methoxy, ethoxy, isopropoxy, tert-butoxy, cyclopropyl; trifluoromethyl, trifluoromethoxy.
R¹² preferably represents hydrogen or C₁-C₄-alkyl.
R¹² particularly preferably represents hydrogen, methyl, ethyl, n- or isopropyl, n-, iso-, sec- or tert-butyl.
Z preferably represents Z¹.
Z¹ preferably represents phenyl which is optionally mono- to pentasubstituted by identical or different substituents, where the substituents are selected from the list W¹.
Z¹ particularly preferably represents monosubstituted phenyl, where the substituents are selected from the list W¹.
Z¹ also particularly preferably represents phenyl which is disubstituted by identical or different substituents, where the substituents are selected from the list W¹.
Z¹ also particularly preferably represents phenyl which is trisubstituted by identical or different substituents, where the substituents are selected from the list W¹.
Z¹ very particularly preferably represents phenyl which is monosubstituted in the 4-position, where the substituents are selected from the list W¹.
Z¹ very particularly preferably represents phenyl which is disubstituted by identical or different substituents in the 3,4-position, where the substituents are selected from the list W¹.
Z¹ very particularly preferably represents phenyl which is disubstituted by identical or different substituents in the 2,4-position, where the substituents are selected from the list W¹.
Z¹ very particularly preferably represents phenyl which is disubstituted by identical or different substituents in the 3,5-position, where the substituents are selected from the list W¹.
Z¹ very particularly preferably represents phenyl which is trisubstituted by identical or different substituents in the 2,4,6-position, where the substituents are selected from the list W¹.
W¹ represents halogen, cyano, nitro, amino, hydroxyl, formyl, carboxyl, carbamoyl, thiocarbamoyl;
   in each case straight-chain or branched alkyl, hydroxyalkyl, oxoalkyl, alkoxy, alkoxyalkyl, alkylthioalkyl, dialkoxyalkyl, alkylthio, alkylsulphinyl or alkylsulphonyl having in each case 1 to 8 carbon atoms;
   in each case straight-chain or branched alkenyl or alkenyloxy having in each case 2 to 6 carbon atoms;
   in each case straight-chain or branched haloalkyl, haloalkoxy, haloalkylthio, haloalkylsulphinyl or haloalkylsulphonyl having in each case 1 to 6 carbon atoms and 1 to 13 identical or different halogen atoms;
   in each case straight-chain or branched haloalkenyl or haloalkenyloxy having in each case 2 to 6 carbon atoms and 1 to 11 identical or different halogen atoms;
   in each case straight-chain or branched alkylamino, dialkylamino, alkylcarbonyl, alkylcarbonyloxy, alkoxycarbonyl, alkylaminocarbonyl, dialkylaminocarbonyl, arylalkylaminocarbonyl, dialkylaminocarbonyloxy having 1 to 6 carbon atoms in the respective hydrocarbon chains, alkenylcarbonyl or alkynylcarbonyl having 2 to 6 carbon atoms in the respective hydrocarbon chains;
   cycloalkyl or cycloalkyloxy having in each case 3 to 6 carbon atoms;
   in each case doubly attached alkylene having 3 or 4 carbon atoms, oxyalkylene having 2 or 3 carbon atoms or dioxyalkylene having 1 or 2 carbon atoms, each of which radicals is optionally mono- to tetrasubstituted by identical or different substituents from the group consisting of fluorine, chlorine, oxo, methyl, trifluoromethyl and ethyl;
   or a grouping —C(Q¹)=N-Q², in which
      Q¹ represents hydrogen, hydroxyl or alkyl having 1 to 4 carbon atoms, haloalkyl having 1 to 4 carbon atoms and 1 to 9 identical or different halogen atoms or cycloalkyl having 1 to 6 carbon atoms and
      Q² represents hydroxyl, amino, methylamino, phenyl, benzyl or represents in each case optionally halogen-, cyano-, hydroxyl-, alkoxy-, alkylthio-, alkylamino-, dialkylamino- or phenyl-substituted alkyl or alkoxy having 1 to 4 carbon atoms, or represents alkenyloxy or alkynyloxy having in each case 2 to 4 carbon atoms,
   and also phenyl, phenoxy, phenylthio, benzoyl, benzoylethenyl, cinnamoyl, heterocyclyl or phenylalkyl, phenylalkyloxy, phenylalkylthio or heterocyclylalkyl having in each case 1 to 3 carbon atoms in the respective alkyl moieties, each of which radicals is optionally mono- to trisubstituted in the cyclic part by halogen and/or straight-chain or branched alkyl or alkoxy having 1 to 4 carbon atoms.
W¹ preferably represents fluorine, chlorine, bromine, methyl, ethyl, n- or iso-propyl, n-, iso-, sec- or tert-butyl, methoxy, ethoxy, n-or iso-propoxy, trifluoromethyl, trifluoroethyl, difluoromethoxy, trifluoromethoxy, difluorochloromethoxy, trifluoroethoxy, in each case doubly attached difluoromethylenedioxy or tetrafluoroethylenedioxy,
   or a grouping —C(Q¹)=N-Q², where
      Q¹ represents hydrogen, methyl, ethyl, trifluoromethyl, or cyclopropyl and
      Q² represents hydroxyl, methoxy, ethoxy, propoxy or isopropoxy.
Z also preferably represents Z².
Z² preferably represents cycloalkyl or bicycloalkyl having in each case 3 to 10 carbon atoms, each of which radicals is optionally mono- to tetrasubstituted by identical or different C₁-C₄-alkyl.
Z² particularly preferably represents cyclopentyl, cyclohexyl, cycloheptyl, cyclooctyl, cyclononyl, bicyclo[2.2.1]heptyl or bicyclo[2.2.2]octyl.
Z also preferably represents Z³.
Z³ preferably represents unsubstituted C₂-C₂₀-alkyl or represents C₁-C₂₀-alkyl which is mono- or polysubstituted by identical or different substituents from the group consisting of fluorine, chlorine, bromine, iodine and C₃-C₆-cycloalkyl, where the cycloalkyl moiety for its part may be mono- to tetrasubstituted by identical or different substituents from the group consisting of fluorine, chlorine, bromine, iodine, C₁-C₄-alkyl and C₁-C₄-haloalkyl.
Z³ particularly preferably represents unsubstituted C₂-C₂₀-alkyl.
Z³ also particularly preferably represents C₁-C₂₀-alkyl which is substituted by chlorine, cyclopropyl, dichlorocyclopropyl, cyclobutyl, cyclopentyl or cyclohexyl.
Z also preferably represents Z⁴.
Z⁴ preferably represents C₂-C₂₀-alkenyl or C₂-C₂₀-alkynyl, each of which is optionally mono- or polysubstituted by identical or different substituents from the group consisting of fluorine, chlorine, bromine, iodine and C₃-C₆-cycloalkyl, where the cycloalkyl moiety for its part may optionally be mono- to tetrasubstituted by identical or different substituents from the group consisting of fluorine, chlorine, bromine, iodine, C₁-C₄-alkyl and C₁-C₄-haloalkyl.
Z⁴ particularly preferably represents C₂-C₂₀-alkenyl or C₂-C₂₀-alkynyl.
Z and R⁴ also preferably together with the carbon atoms to which they are attached represent a 5- or 6-membered carbocyclic or heterocyclic ring which is optionally mono- to tetrasubstituted by identical or different substituents.
Z and R⁴ also particularly preferably together with the carbon atoms to which they are attached represent a 5- or 6membered carbocyclic ring which is optionally mono-, di- or trisubstituted by methyl.

Preference is furthermore given to compounds of the formula (Ic) 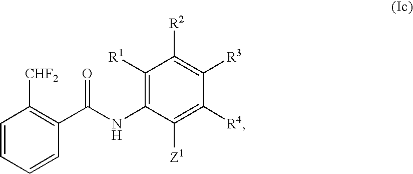
in which R¹, R², R³, R⁴ and Z¹ are as defined above.

Preference is furthermore given to compounds of the formula (Id) 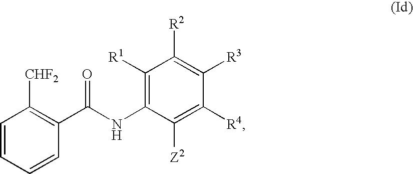
in which R¹, R², R³, R⁴ and Z²are as defined above.

Preference is furthermore given to compounds of the formula (Ie) 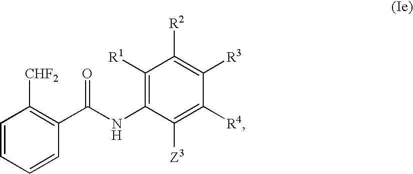
in which R¹, R², R³, R⁴ and Z³ are as defined above.

Preference is furthermore given to compounds of the formula (If) 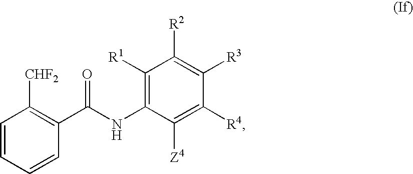
in which R¹, R², R³, R⁴and Z² are as defined above.

Preference is furthermore given to compounds of the formula (Ib) 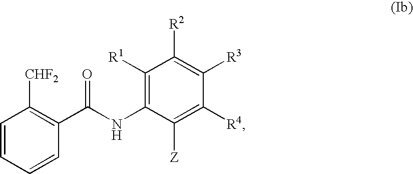
in which R¹, R², R³, R⁴ and Z are as defined above.

Preference is furthermore given to compounds of the formula (Ig) 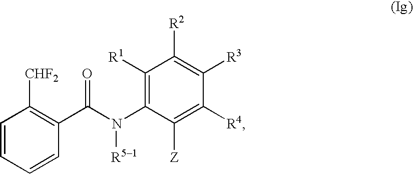
in which R¹, R², R³, R⁴, R⁵⁻¹ and Z are as defined above.
R⁵⁻¹ preferably represents C₁-C₆-alkyl, C₁-C₄-alkylsulphinyl, C₁-C₄-alkylsulphonyl, C₁-C₃-alkoxy-C₁-C₃-alkyl, C₃-C₆-cycloalkyl; C₁-C₄-haloalkyl, C₁-C₄-haloalkylthio, C₁-C₄-haloalkylsulphinyl, C₁-C₄-haloalkylsulphonyl, halo-C₁-C₃-alkoxy-C₁-C₃-alkyl, C₃-C₆-halocycloalkyl having in each case 1 to 9 fluorine, chlorine and/or bromine atoms, formyl-C₁-C₃-alkyl, (C₁-C₃-alkyl)carbonyl-C₁-C₃-alkyl, (C₁-C₃-alkoxycarbonyl-C₁-C₃-alkyl; (C₁-C₃-haloalkyl)carbonyl-C₁-C₃-alkyl, (C₁-C₃-haloalkoxy)carbonyl-C₁-C₃-alkyl having in each case 1 to 7 fluorine, chlorine and/or bromine atoms, (C₁-C₃-alkyl)carbonyl-C₁-C₃-haloalkyl, (C₁-C₃-alkoxy)carbonyl-C₁-C₃-haloalkyl having in each case 1 to 6 fluorine, chlorine and/or bromine atoms, (C₁-C₃-haloalkyl)carbonyl-C₁-C₃-haloalkyl, (C₁-C₃-haloalkoxy)carbonyl-C₁-C₃-haloalkyl having in each case 1 to 13 fluorine, chlorine and/or bromine atoms; —COR⁶, —CONR⁷R⁸ or —CH₂NR⁹R¹⁰.
R⁵⁻¹ particularly preferably represents methyl, ethyl, n- or isopropyl, n-, iso-, sec- or tert-butyl, pentyl or hexyl, methylsulphinyl, ethylsulphinyl, n- or isopropylsulphinyl, n-, iso-, sec- or tert-butylsulphinyl, methylsulphonyl, ethylsulphonyl, n- or isopropylsulphonyl, n-, iso-, sec- or tert-butylsulphonyl, methoxymethyl, methoxyethyl, ethoxymethyl, ethoxyethyl, cyclopropyl, cyclopentyl, cyclohexyl, trifluoromethyl, trichloromethyl, trifluoroethyl, difluoromethylthio, difluorochloromethylthio, trifluoromethylthio, trifluoromethylsulphinyl, trifluoromethylsulphonyl, trifluoromethoxymethyl, —CH₂—CHO, —CH₂CH₂—CHO, —CH₂—CO—CH₃, —CH₂—CO—CH₂CH₃, —CH₂—CO—CH(CH₃)₂, —CH₂CH₂—CO—CH₃, —CH₂CH₂—CO—CH₂CH₃, —CH₂CH₂—CO—CH(CH₃)₂, —CH₂—C(O)OCH₃, —CH₂—C(O)OCH₂CH₃, —CH₂—C(O)OCH(CH₃)₂, —CH₂CH₂—C(O)OCH₃, —CH₂CH₂—C(O)OCH₂CH₃, —CH₂CH₂—C(O)OCH(CH₃)₂, —CH₂—CO—CF₃, —CH₂CO—CCl₃, —CH₂—CO—CH₂CF₃, —CH₂—CO—CH₂CCl₃, —CH₂CH₂—CO—CH₂CF₃, —CH₂CH₂—CO—CH₂CCl₃, —CH₂—C(O)OCH₂CF₃, —CH₂—C(O)OCF₂CF₃, —CH₂—C(O)OCH₂CCl₃, —CH₂—C(O)OCCl₂CCl₃, —CH₂CH₂—C(O)OCH₂CF₃, —CH₂CH₂—C(O)OCF₂CF₃, —CH₂CH₂—C(O)OCH₂CCl₃, —CH₂CH₂—C(O)O—CCl₂CCl₃; —COR⁶, —CONR⁷R⁸ or —CH₂NR⁹R¹⁰.
R⁵⁻¹ very particularly preferably represents methyl, methoxymethyl, —CH₂—CHO, —CH₂CH₂—CHO, —CH₂—CO—CH₃, —CH₂—CO—CH₂CH₃, —CH₂—CO—CH(CH₃)₂ or —COR⁶.

Saturated or unsaturated hydrocarbon radicals, such as alkyl or alkenyl, can in each case be straight-chain or branched as far as this is possible, including in combination with heteroatoms, such as, for example, in alkoxy.

The definition C₁-C₂₀-alkyl embraces the widest range defined here for an alkyl radical. Specifically, this definition includes the meanings methyl, ethyl, n-, isopropyl, n-, iso-, sec-, tert-butyl, and in each case all isomeric pentyls, hexyls, heptyls, octyls, nonyls, decyls, undecyls, dodecyls, tridecyls, tetradecyls, pentadecyls, hexadecyls, heptadecyls, octadecyls, nonadecyls and eicosyls. Among these, the meanings methyl, ethyl, n-, isopropyl, n-, iso-, sec-, tert-butyl, n-pentyl, 1-methylbutyl, 2-methyl-butyl, 3-methylbutyl, 1,2-dimethylpropyl, 2,2-dimethylpropyl, n-hexyl, 1-methylpentyl, 4-methyl-pentyl, 1,3-dimethylbutyl, 3,3-dimethylbutyl, 1,2,2-trimethylpropyl, n-heptyl, 1-methylhexyl, 5-methylhexyl, 1,4-dimethylpentyl, 4,4-dimethylpentyl, 1,3,3-trimethylbutyl, 1,2,3-trimethylbutyl.

The definition C₂-C₂₀-alkenyl embraces the widest range defined here for an alkenyl radical. Specifically, this definition includes the meanings ethenyl, 1-propenyl, 2-propenyl, isopropenyl, 1-butenyl, 2-butenyl, 3-butenyl, 1-methyl-1-propenyl, 2-methyl-1-propenyl, 1-methyl-2-propenyl, 2-methyl-2-propenyl, 1-ethylethenyl, and in each case all isomeric pentenyls, hexenyls, heptenyls, octenyls, nonenyls, decenyls, undecenyls, dodecenyls, tridecenyls, tetradecenyls, pentadecenyls, hexadecenyls, heptadecenyls, octadecenyls, nonadecenyls and eicosenyls. Among these, preference is given to the meanings ethenyl, 1-propenyl, 2-propenyl, 1-butenyl, 2-butenyl, 3-butenyl, 1-methyl-1-propenyl, 2-methyl-1-propenyl, 1-pentenyl, 4-pentenyl, 1-methyl-1-butenyl, 1,2-dimethyl-1-propenyl, 1-hexenyl, 5-hexenyl, 1-methyl-1-pentenyl, 1,3-dimethyl-1-butenyl, 1-methyl-1-hexenyl, 1,3,3-trimethyl-1-butenyl.

The definition C₂-C₂₀-alkynyl embraces the widest range defined here for an alkynyl radical. Specifically, this definition includes the meanings ethynyl, 1-propynyl, 2-propynyl, 1-butynyl, 2-butynyl, 3-butynyl, 1-methyl-2-propynyl, and in each case all isomeric pentynyls, hexynyls, heptynyls, octynyls, nonynyls, decynyls, undecynyls, dodecynyls, tridecynyls, tetradecynyls, pentadecynyls, hexadecynyls, heptadecynyls, octadecynyls, nonadecynyls and eicosynyls. Among these, preference is given to the meanings ethynyl, 1-propynyl, 1-butynyl, 3-butynyl, 1-methyl-2-propynyl, 1-pentynyl, 4-pentynyl, 1-hexynyl, 5-hexynyl, 3,3-dimethyl-1-butynyl, 4,4-dimethyl-1-pentynyl, 4,4-dimethyl-2-pentynyl, 1,4-dimethyl-2-pentynyl.

Optionally substituted radicals may be mono- or polysubstituted, where in the case of polysubstitution the substituents can be identical or different.

Halogen-substituted radicals, such as, for example, haloalkyl, are mono- or polyhalogenated. In the case of polyhalogenation, the halogen atoms can be identical or different. Here, halogen denotes fluorine, chlorine, bromine and iodine, in particular fluorine, chlorine and bromine.

The general or preferred radical definitions or illustrations given above can be combined between the respective ranges and preferred ranges as desired. The definitions apply both to the end products and, correspondingly, to precursors and intermediates.

Explanation of the Processes and Intermediates:

Process (a)

Using 2-difluoromethyl)benzoyl chloride and 4′-chloro-3′-fluoro-1,1′-biphenyl-2-amine as starting materials, the course of the process (a) according to the invention can be illustrated by the formula scheme below.

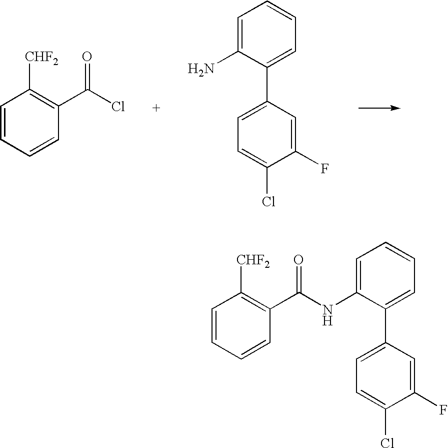

Formula (II) provides a general definition of the difluoromethylbenzoyl derivatives required as starting materials for carrying out the process (a) according to the invention. In this formula (II), X¹ preferably represents chlorine or hydroxyl.

The difluoromethylbenzoyl derivatives of the formula (II) are known. They are obtained when
j) 2-formylbenzonitrile of the formula (XIV) 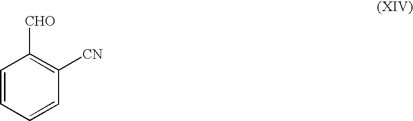
   is, in a first step, fluorinated with (diethylamino)sulphur trifluoride in the presence of a diluent (for example methylene chloride),
   and the resulting 2-difluormethylbenzonitrile of the formula (XV) 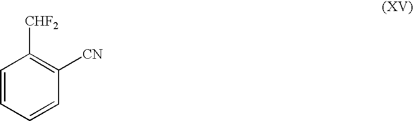
   is, in a second step, reacted with a base (for example NaOH or KOH) [compounds of the formula (II) in which X¹ represents hydroxyl]
   and this acid is optionally, in a third step, reacted with a chlorinating agent (for example thionyl chloride, oxalyl chloride) in the presence of a diluent (for example toluene, methylene chloride) to give the corresponding acid chloride [compounds of the formula (II) in which X¹ represents chlorine].

The formula (III) provides a general definition of the aniline derivatives furthermore required as starting materials for carrying out the process (a) according to the invention. In this formula (III), R¹, R², R³, R⁴, R⁵ and Z preferably, particularly preferably and very particularly preferably have those meanings which have already been mentioned in connection with the description of the compounds of the formula (I) according to the invention as being preferred, particularly preferred and very particularly preferred, respectively, for these radicals.

Most of the starting materials of the formula (III) are known, and/or they can be prepared by known processes (cf., for example, Bull. Korean Chem. Soc. 2000, 21, 165-166; Chem. Pharm. Bull. 1992, 40, 240-244; Heterocycles 1989 29, 1013-1016; J. Med. Chem. 1996, 39, 892-903; Synthesis 1995, 713-16; Synth. Commun. 1994, 24, 267-272; Synthesis 1994, 142-144; DE-A 27 27 416; DE-A 102 190 35; JP-A 9-132567; EP-A 0 824 099; WO 93/11117; EP-A 0 545 099; EP-A 0 589 301; EP-A 0 589 313 and WO 02/38542).

It is also possible to prepare initially aniline derivatives of the formula (III) in which R⁵ is hydrogen and then to derivatize the compounds obtained using customary methods (for example analogously to the process (i) according to the invention).

Process (b)

Using N-(2-bromophenyl)-2-(difluoromethyl)benzamide and 4-chloro-3-fluorophenylboronic acid as starting materials and a catalyst, the course of the process (b) according to the invention can be illustrated by the formula scheme below. 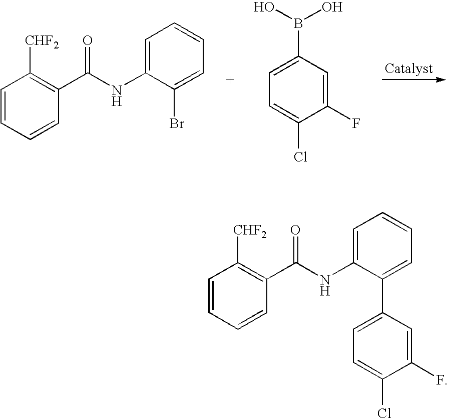
The formula (IV) provides a general definition of the halodifluoromethylbenzanilides required as starting materials for carrying out the process (b) according to the invention. In this formula (IV), R¹, R², R³, R⁴ and R⁵ preferably, particularly preferably and very particularly preferably have those meanings which have already been mentioned in connection with the description of the compounds of the formula (I) according to the invention as being preferred, particularly preferred and very particularly preferred, respectively, for these radicals. X² is bromine or iodine.

The halodifluoromethylbenzanilides of the formula (IV) have hitherto not been disclosed. As novel chemical compounds, they also form part of the subject-matter of the present application. They are obtained when
k) difluoromethylbenzoyl derivatives of the formula (II) 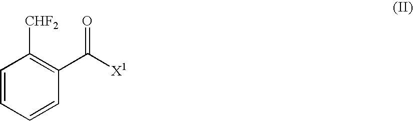
   in which X¹ represents halogen or hydroxyl,
   are reacted with haloanilines of the formula (XVI), 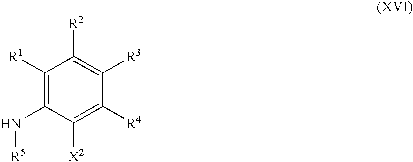
   in which R¹, R², R³, R⁴, R⁵ and X² are as defined above,
   if appropriate in the presence of a catalyst, if appropriate in the presence of a condensing agent, if appropriate in the presence of an acid binder and if appropriate in the presence of a diluent.
      Process (k)

Using 2-difluoromethyl)benzoyl chloride and 2-bromoaniline as starting materials, the course of the process (i) according to the invention can be illustrated by the formula scheme below.

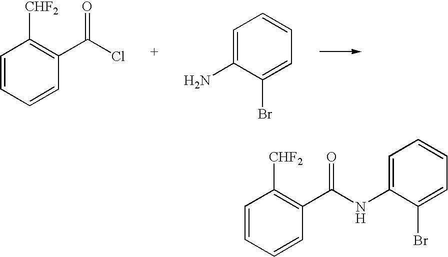

The difluoromethylbenzoyl derivatives of the formula (II) required as starting materials for carrying out the process (k) according to the invention have already been described further above, in connection with the process (a) according to the invention.

The formula (XVI) provides a general definition of the haloanilines furthermore required as starting materials for carrying out the process (k) according to the invention. In this formula (XVI), R¹, R², R³, R⁴, R⁵ and X² preferably, particularly preferably and very particularly preferably have those meanings which have already been mentioned in connection with the description of the compounds of the formula (I) according to the invention or of the intermediates of the formula (III) as being preferred, particularly preferred and very particularly preferred, respectively, for these radicals.

The haloanilines of the formula (XVI) are known chemicals for synthesis or can be obtained by known processes. If R⁵ does not represent hydrogen, the radical R⁵ can be introduced at the stage of the compounds of the formula (XVI) using customary derivatization methods. It is also possible to prepare initially compounds of the formula (IV) in which R⁵ is hydrogen and then to derivatize the products obtained using customary methods (cf. the process (i) according to the invention).

The formula (V) provides a general definition of the boronic acid derivatives furthermore required as starting materials for carrying out the process (b) according to the invention. In this formula (V), Z¹ preferably, particularly preferably and very particularly preferably has those meanings which have already been mentioned in connection with the description of the compounds of the formula (I) according to the invention as being preferred, particularly preferred and very particularly preferred, respectively, for Z¹. A¹ and A² each represent hydrogen or together represent tetramethylethylene.

The boronic acid derivatives of the formula (V) are known and/or can be prepared by known processes (cf., for example, WO 01/90084 and U.S. Pat. No. 5,633,218).

Process (c)

Using 2-{[2-(difluoromethyl)benzoyl]amino}phenylboronic acid and 1-bromo-4-chloro-3-fluorobenzene as starting materials and a catalyst, the course of the process (c) according to the invention can be illustrated by the formula scheme below.

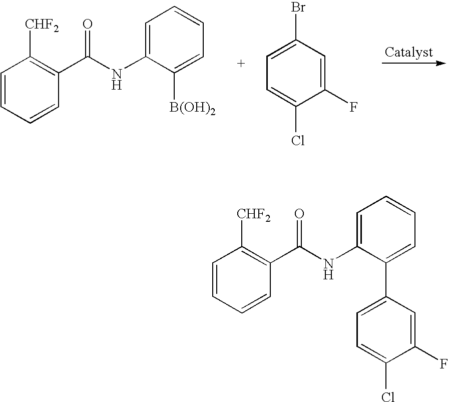

The formula (VI) provides a general definition of the difluoromethylbenzamideboronic acid derivatives required as starting materials for carrying out the process (c) according to the invention. In this formula (VI), R¹, R², R³, R⁴ and R⁵ preferably, particularly preferably and very particularly preferably have those meanings which have already been mentioned in connection with the description of the compounds of the formula (I) according to the invention as being preferred, particularly preferred and very particularly preferred, respectively, for these radicals. A³ and A⁴ each represent hydrogen or together represent tetramethylethylene.

The difluoromethylbenzamideboronic acid derivatives of the formula (VI) have hitherto not been disclosed. They are novel chemical compounds and also form part of the subject-matter of the present application. They are obtained when
l) difluoromethylbenzoyl derivatives of the formula (II) 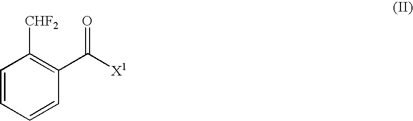
   in which X¹ represents halogen or hydroxyl
   are reacted with anilineboronic acid derivatives of the formula (XVII) 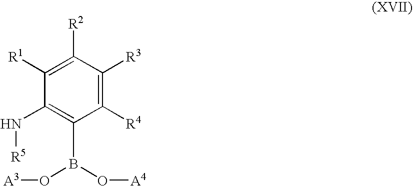
   in which
   R¹, R², R³, R⁴, R⁵, A³ and A⁴ are as defined above,
   if appropriate in the presence of a catalyst, if appropriate in the presence of a condensing agent, if appropriate in the presence of an acid binder and if appropriate in the presence of a diluent.
      Process (l)

Using 2-difluoromethyl)benzoyl chloride and 2-aminophenylboronic acid as starting materials, the course of the process (l) according to the invention can be illustrated by the formula scheme below.

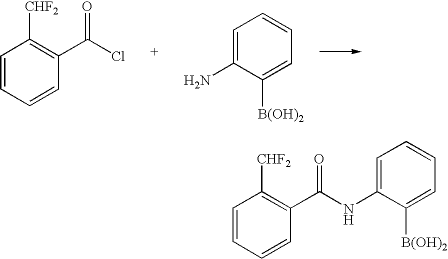

The difluoromethylbenzoyl derivatives of the formula (II) required as starting materials for carrying out the process (l) according to the invention have already been described further above, in connection with the process (a) according to the invention.

The formula (XVII) provides a general definition of the anilineboronic acid derivatives furthermore required as starting materials for carrying out the process (l) according to the invention. In this formula (XVII), R¹, R², R³, R⁴ and R⁵ preferably, particularly preferably and very particularly preferably have those meanings which have already been mentioned in connection with the description of the compounds of the formula (I) according to the invention as being preferred, particularly preferred and very particularly preferred, respectively, for these radicals. A³ and A⁴ each represent hydrogen or together represent tetramethylethylene.

The anilineboronic acid derivatives of the formula (XVII) are known chemicals for synthesis or can be obtained by known processes. If R⁵ does not represent hydrogen, the radical R⁵ can be introduced at the stage of the compounds of the formula (XVII) using customary derivatization methods. It is also possible to prepare initially compounds of the formula (VI) in which R⁵ represents hydrogen and then to derivative the products obtained using customary methods (cf. the process (i) according to the invention).

The formula (VII) provides a general definition of the phenyl derivatives furthermore required as starting materials for carrying out the process (c) according to the invention. In this formula (VII), Z¹ preferably, particularly preferably and very particularly preferably has those meanings which have already been mentioned in connection with the description of the compounds of the formula (I) according to the invention as being preferred, particularly preferred and very particularly preferred, respectively, for Z¹. X³ represents chlorine, bromine, iodine or trifluoromethylsulphonate.

The phenyl derivatives of the formula (VII) are known chemicals for synthesis.

Process (d)

Using N-(2-bromophenyl)-2-difluoromethyl)benzamide and 1-bromo-4-chloro-3-fluorobenzene as starting materials and a catalyst and 4,4,4′,4′,5,5,5′,5′-octamethyl-2,2′-bis-1,3,2-dioxaborolane, the course of the process (d) according to the invention can be illustrated by the formula scheme below.

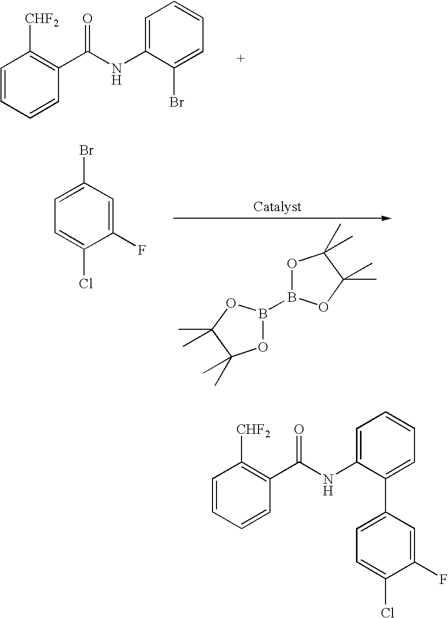

The halodifluoromethylbenzanilides of the formula (IV) and the phenyl derivatives of the formula (VII) required as starting materials for carrying out the process (d) according to the invention have already been described further above, in connection with the processes (b) and (c) according to the invention.

4,4,4′,5,5,5′,5′-Octamethyl-2,2′-bis-1,3,2-dioxaborolane, furthermore required for carrying out the process (d) according to the invention, is a commercially available chemical for synthesis.

Process (e)

If, for example, 2-(difluoromethyl)-N-{2-(1,3-dimethyl-1-butenyl)phenyl}benzamide is hydrogenated, the course of the process (e) according to the invention can be illustrated by the formula scheme below.

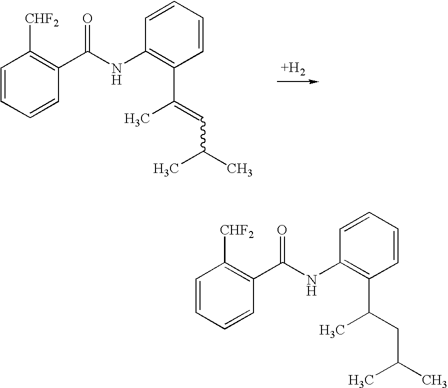

Formula (Ia) provides a general definition of the difluoromethylbenzanilides required as starting materials for carrying out the process (e) according to the invention. In this formula (Ia), R¹, R², R³, R⁴ and R⁵ preferably, particularly preferably and very particularly preferably have those meanings which have already been mentioned in connection with the description of the compounds of the formula (I) according to the invention as being preferred, particularly preferred and very particularly preferred, respectively, for these radicals.

The compounds of the formula (Ia) are compounds according to the invention and can be prepared by processes (a), (f), (g) or (h).

Process (f)

If, for example, 2-difluoromethyl)N-[2-(1-hydroxy-1,3-dimethylbutyl)phenyl]benzamide is dehydrated, the course of the process (f) according to the invention can be illustrated by the formula scheme below.

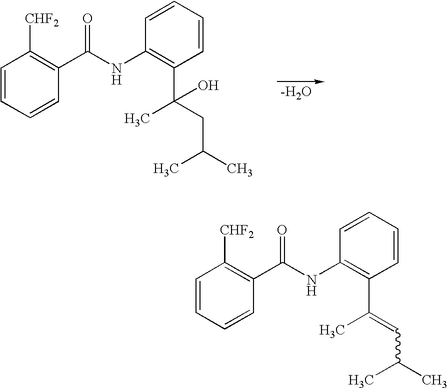

The formula (VIII) provides a general definition of the hydroxyalkyldifluoromethylbenzanilides required as starting materials for carrying out the process (f) according to the invention. In this formula (VII), R¹, R², R³, R⁴ and R⁵ preferably, particularly preferably and very particularly preferably have those meanings which have already been mentioned in connection with the description of the compounds of the formula (I) according to the invention as being preferred, particularly preferred and very particularly preferred, respectively, for these radicals.
X⁵ preferably represents C₂-C₁₂-hydroxyalkyl which is optionally additionally mono- to tetrasubstituted by identical or different substituents from the group consisting of chlorine, fluorine, bromine and C₃-C₆-cycloalkyl, where the cycloalkyl moiety for its part may optionally be substituted by halogen and/or C₁-C₄-alkyl.
X⁵ particularly preferably represents in each case straight-chain or branched hydroxyethyl, hydroxypropyl, hydroxybutyl, hydroxypentyl, hydroxyhexyl, hydroxyheptyl, hydroxyoctyl, hydroxynonyl or hydroxydecyl, each of which may be attached in any position and each of which is optionally mono- to tetrasubstituted by identical or different substituents from the group consisting of fluorine, cyclopropyl, difluorocyclopropyl, cyclobutyl, cyclopentyl and cyclohexyl.

The compounds of the formula (VIII) have hitherto not been disclosed and, as novel compounds, also form part of the subject-matter of the present application.

It has also been found that the hydroxyalkyldifluoromethylbenzanilides of the formula (VIII) have very good microbicidal properties and can be used for controlling unwanted microorganisms both in crop protection and in the protection of materials.

The hydroxyalkyldifluoromethylbenzanilides of the formula (VIII) are obtained when
m) difluoromethylbenzoyl derivatives of the formula (II) 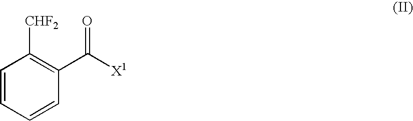
   in which X¹ represents halogen or hydroxyl
   are reacted with hydroxyalkylaniline derivatives of the formula (XVIII) 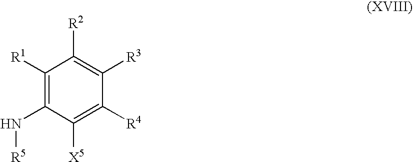
   in which
   R¹, R², R³, R⁴, R⁵ and X⁵ are as defined above,
   if appropriate in the presence of a catalyst, if appropriate in the presence of a condensing agent, if appropriate in the presence of an acid binder and if appropriate in the presence of a diluent.
      Process (m)

Using, for example, 2-difluoromethyl)benzoyl chloride and 2-(2-aminophenyl)-2-pentanol as starting materials, the course of the process (m) according to the invention can be illustrated by the formula scheme below:

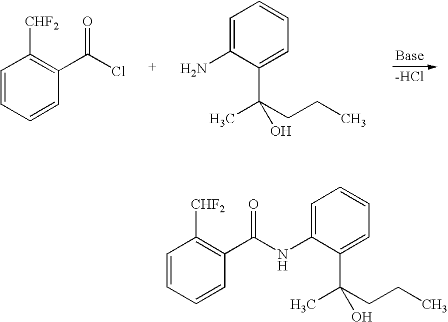

The difluoromethylbenzoyl derivatives of the formula (II) required as starting materials for carrying out the process (m) according to the invention have already been described further above, in connection with the process (a) according to the invention.

The formula (XVIII) provides a general definition of the hydroxyalkylaniline derivatives furthermore required as starting materials for carrying out the process (l) according to the invention. In this formula (XVIII), R¹, R², R³, R⁴, R⁵ and X⁵ preferably, particularly preferably and very particularly preferably have those meanings which have already been mentioned in connection with the description of the compounds of the formulae (I) and (VIII) according to the invention as being preferred, particularly preferred and very particularly preferred, respectively, for these radicals.

The hydroxyalkylaniline derivatives of the formula (XVIII) are known and/or can be obtained by known methods (cf., for example, U.S. Pat. No. 3,917,592 or EP-A 0 824 099). If R⁵ does not represent hydrogen, the radical R⁵ can be introduced at the stage of the compounds of the formula (XVIII) using customary derivatization methods. It is also possible to prepare initially compounds of the formula (VIII) in which R⁵ represents hydrogen and then to derivative the products obtained using customary methods (cf. the process (i) according to the invention).

Process (g)

Using, for example, N-(2-bromophenyl)-2-(difluoromethyl)benzamide and 1-hexyne as starting materials and a catalyst, the course of the process (g) according to the invention can be illustrated by the formula scheme below.

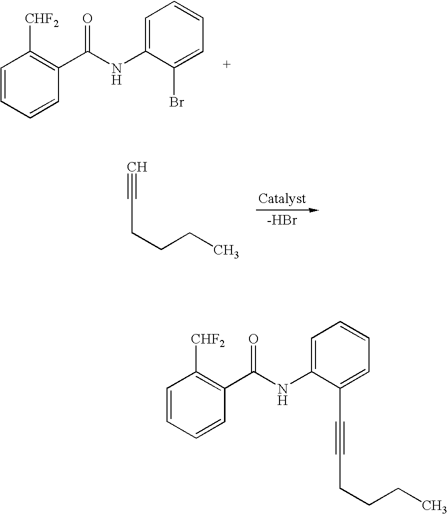

The halodifluoromethylbenzanilides of the formula (IV) required as starting materials for carrying out the process (g) according to the invention have already been described further above, in connection with the process (c) according to the invention.

The formula (IX) provides a general definition of the alkynes furthermore required as starting materials for carrying out the process (g) according to the invention.
A⁵ preferably represents C₂-C₁₀-alkyl which is optionally mono- to tetrasubstituted by identical or different substituents from the group consisting of fluorine, chlorine, bromine and C₃-C₆-cycloalkyl, where the cycloalkyl moiety for its part may optionally be substituted by halogen and/or C₁-C₄-alkyl.
A⁵ particularly preferably represents in each case straight-chain or branched ethyl, propyl, butyl, pentyl, hexyl, heptyl or octyl, each of which may be attached in any position and each of which is mono- to tetrasubstituted by identical or different substituents from the group consisting of fluorine, cyclopropyl, difluorocyclopropyl, cyclobutyl, cyclopentyl and cyclohexyl.

The alkynes of the formula (IX) are known chemicals for synthesis.

The formula (X) provides a general definition of the alkenes furthermore alternatively required as starting materials for carrying out the process (g) according to the invention.
A⁶, A⁷ and A⁸ independently of one another preferably each represent hydrogen or alkyl which is optionally mono- to tetrasubstituted by identical or different substituents from the group consisting of fluorine, chlorine, bromine and C₃-C₆-cycloalkyl, where the cycloalkyl moiety for its part may optionally be substituted by halogen and/or C₁-C₄-alkyl and where the total number of carbon atoms of the open-chain part of the molecule does not exceed the number 12.
A⁶, A⁷ and A⁸ independently of one another particularly preferably each represent hydrogen or in each case straight-chain or branched ethyl, propyl, butyl, pentyl, hexyl, heptyl or octyl, each of which may be attached in any position and each of which is optionally mono- to tetrasubstituted by identical or different substituents from the group consisting of fluorine, cyclopropyl, difluorocyclopropyl, cyclobutyl, cyclopentyl and cyclohexyl, where the total number of carbon atoms of the open-chain part of the molecule does not exceed the number 12.

The alkenes of the formula (VII) are known chemicals for synthesis.

Process (h)

Using N-(2-acetylphenyl)-2-difluoromethyl)benzamide and butyl(triphenyl)phosphonium iodide as starting materials, the course of the process (h) according to the invention can be illustrated by the formula scheme below:

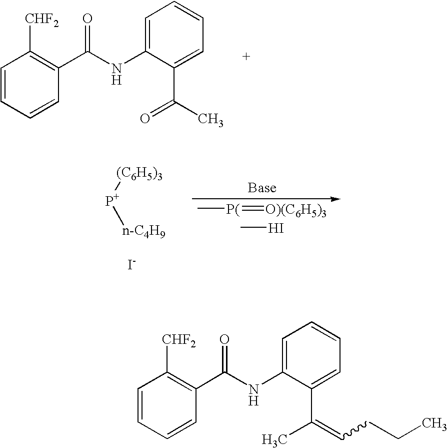

The formula (XI) provides a general definition of the ketones required as starting materials for carrying out the process (h) according to the invention. In this formula, R¹, R², R³, R⁴ and R⁵ preferably, particularly preferably and very particularly preferably have those meanings which have already been mentioned in connection with the description of the compounds of the formula (I) according to the invention as being preferred, particularly preferred and very particularly preferred, respectively, for these radicals.
A⁹ preferably represents C₂-C₁₀-alkyl which is optionally mono- to tetrasubstituted by identical or different substituents from the group consisting of fluorine, chlorine, bromine and C₃-C₆-cycloalkyl, where the cycloalkyl moiety for its part may optionally be substituted by halogen and/or C₁-C₄-alkyl.
A⁹ particularly preferably represents in each case straight-chain or branched, ethyl, propyl, butyl, pentyl, hexyl, heptyl or octyl, each of which may be attached in any position and each of which is optionally mono- to tetrasubstituted by identical or different substituents from the group consisting of fluorine, cyclopropyl, difluorocyclopropyl, cyclobutyl, cyclopentyl and cyclohexyl.

The ketones of the formula (VIII) have hitherto not been disclosed. As novel chemical compounds, they also form part of the subject-matter of the present application. They are obtained when
n) difluoromethylbenzoyl derivatives of the formula (II) 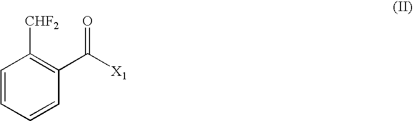
   in which X¹ represents halogen or hydroxyl,
   are reacted with ketoanilines of the formula (XIX) 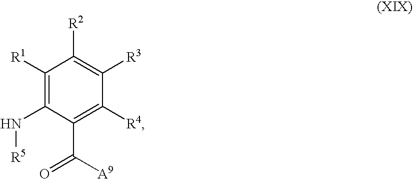
   in which R¹, R², R³, R⁴, R⁵ and A⁹ are as defined above,
   if appropriate in the presence of a catalyst, if appropriate in the presence of a condensing agent, if appropriate in the presence of an acid binder and if appropriate in the presence of a diluent.
      Process (n)

Using 2-(difluoromethyl)benzoyl chloride and 1-(2-aminophenyl)ethanone as starting materials, the course of the process (n) according to the invention can be illustrated by the formula scheme below:

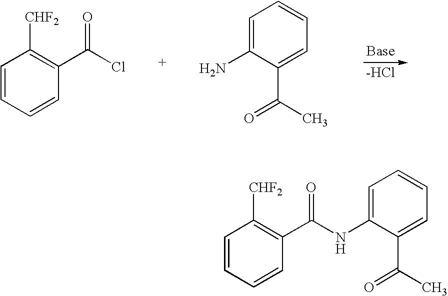

The difluoromethylbenzoyl derivatives of the formula (II) required as starting materials for carrying out the process (n) according to the invention have already been described further above, in connection with the process (a) according to the invention.

Formula (XIX) provides a general definition of the ketoanilines furthermore required as starting materials for carrying out the process (n) according to the invention. In this formula (XIX), R¹, R², R³, R⁴, R⁵ and A⁹ preferably, particularly preferably and very particularly preferably have those meanings which have already been mentioned in connection with the description of the compounds of the formulae (I) and (XI) according to the invention as being preferred, particularly preferred and very particularly preferred, respectively, for these radicals.

The ketoanilines of the formula (XIX) are known (cf. J. Am. Chem. Soc. 1978, 100 4842-4857 or U.S. Pat. No. 4,032,573), and/or they can be obtained by known methods. If R⁵ does not represent hydrogen, the radical R⁵ can be introduced at the stage of the compounds of the formula (XXII) using customary derivatization methods. It is also possible to prepare initially compounds of the formula (VIII) in which R⁵ represents hydrogen and then to derivatize the products obtained using customary methods (cf. the process (i) according to the invention).

The formula (XII) provides a general definition of the phosphorus compounds furthermore required as starting materials for carrying out the process (h) according to the invention.
A¹⁰ preferably represents C₂-C₁₀-alkyl which is optionally mono- to tetrasubstituted by identical or different substituents from the group consisting of chlorine, fluorine, bromine and C₃-C₆-cycloalkyl, where the cycloalkyl moiety for its part may optionally be substituted by halogen and/or C₁-C₄-alkyl.
A¹⁰ particularly preferably represents in each case straight-chain or branched ethyl, propyl, butyl, pentyl, hexyl, heptyl or octyl, each of which may be attached in any position and each of which is optionally mono- to tetrasubstituted by identical or different substituents from the group consisting of fluorine, cyclopropyl, difluorocyclopropyl, cyclobutyl, cyclopentyl and cyclohexyl.
Px preferably represents a grouping —P⁺(C₆H₅)₃Cl⁻, —P⁺(C₆H₅)₃Br⁻, —P⁺(C₆H₅)₃I⁻, —P(═O)(OCH₃)₃ or —P(═O)(OC₂H₅)₃.

The phosphorus compounds of the formula (XII) are known and/or can be prepared by known processes (cf. Justus Liebigs Ann. Chem. 1953, 580, 44-57 or Pure Appl. Chem. 1964, 9, 307-335).

Process (i)

Using N-(4′-chloro-3′-fluoro-1,1′-biphenyl-2-yl)-2-difluoromethyl)benzamide and acetyl chloride as starting materials, the course of the process (i) according to the invention can be illustrated by the formula scheme below:

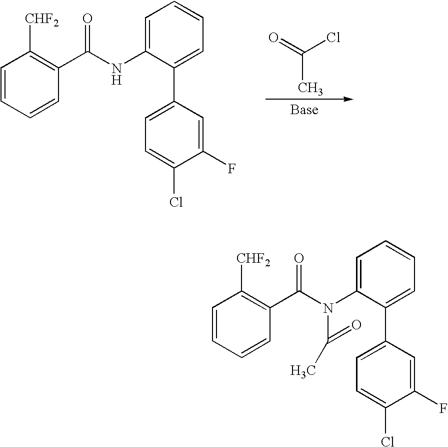

The formula (Ib) provides a general definition of the difluoromethylbenzanilides required as starting materials for carrying out the process (i) according to the invention. In this formula (Ib), R¹, R², R³, R⁴ and Z preferably, particularly preferably and very particularly preferably have those meanings which have already been mentioned in connection with the description of the compounds of the formula (I) according to the invention as being preferred, particularly preferred and very particularly preferred, respectively, for these radicals.

The compounds of the formula (Ib) are compounds according to the invention and can be prepared according to processes (a) to (h).

The formula (XIII) provides a general definition of the halides furthermore required as starting materials for carrying out the process (i) according to the invention. In this formula (XIII), R⁵⁻¹ preferably, particularly preferably and very particularly preferably has those meanings which have already been mentioned above in connection with the description of the compounds of the formula (Ig) as being preferred, particularly preferred and very particularly preferred for these radicals. X⁶ represents chlorine, bromine or iodine.

Halides of the formula (XIII) are known.

Reaction Conditions

Suitable diluents for carrying out the processes (a), (k), (l), (m) and (n) according to the invention are all inert organic solvents. These preferably include aliphatic, alicyclic or aromatic hydrocarbons, such as, for example, petroleum ether, hexane, heptane, cyclohexane, methylcyclohexane, benzene, toluene, xylene or decalin; halogenated hydrocarbons, such as, for example, chlorobenzene, dichlorobenzene, dichloromethane, chloroform, carbon tetrachloride, dichloroethane or trichloroethane; ethers, such as diethyl ether, diisopropyl ether, methyl tert-butyl ether, methyl tert-amyl ether, dioxane, tetrahydrofuran, 1,2-dimethoxyethane, 1,2-diethoxyethane or anisole; ketones, such as acetone, butanone, methyl isobutyl ketone or cyclohexanone; nitriles, such as acetonitrile, propionitrile, n- or iso-butyronitrile or benzonitrile; amides, such as N,N-dimethylformamide, N,N-dimethylacetamide, N-methylformanilide, N-methylpyrrolidone or hexamethylphosphoric triamide; mixtures thereof with water or pure water.

The processes (a), (k), (l), (m) and (n) according to the invention are, if appropriate, carried out in the presence of a suitable acid acceptor. Suitable acid acceptors are all customary inorganic or organic bases. These preferably include alkaline earth metal or alkali metal hydrides, hydroxides, amides, alkoxides, acetates, carbonates or bicarbonates, such as, for example, sodium hydride, sodium amide, lithium diisopropylamide, sodium methoxide, sodium ethoxide, potassium tert-butoxide, sodium hydroxide, potassium hydroxide, sodium acetate, sodium carbonate, potassium carbonate, potassium bicarbonate, sodium bicarbonate or ammonium carbonate, and also tertiary amines, such as trimethylamine, triethylamine, tributylamine, N,N-dimethylaniline, N,N-dimethylbenzylamine, pyridine, N-methylpiperidine, N-methylmorpholine, N,N-dimethylaminopyridine, diazabicyclooctane (DABCO), diazabicyclononene (DBN) or diazabicycloundecene (DBU).

The processes (a), (k), (l), (m) and (n) according to the invention are, if appropriate, carried out in the presence of a suitable condensing agent. Suitable condensing agents are all condensing agents which are customarily used for such amidation reactions. Examples which may be mentioned are acid halide formers, such as phosgene, phosphorus tribromide, phosphorus trichloride, phosphorus pentachloride, phosphorus oxychloride or thionyl chloride; anhydride formers, such as ethyl chloroformate, methyl chloroformate, isopropyl chloroformate, isobutyl chloroformate or methanesulfonyl chloride; carbodiimides, such as N,N′-dicyclohexylcarbodiimide (DCC), or other customary condensing agents, such as phosphorus pentoxide, polyphosphoric acid, N,N′-carbonyldiimidazole, 2-ethoxy-N-ethoxycarbonyl-1,2-dihydroquinoline (EEDQ), triphenylphosphine/carbon tetrachloride or bromotripyrrolidinophosphonium hexafluorophosphate.

The processes (a), (k), (l), (m) and (n) according to the invention are, if appropriate, carried out in the presence of a catalyst. Examples which may be mentioned are 4-dimethylaminopyridine, 1-hydroxybenzotriazole and dimethylformamide.

When carrying out the processes (a), (k), (l), (m) and (n) according to the invention, the reaction temperatures can be varied within a relatively wide range. In general, the processes are carried out at temperatures of from 0° C. to 150° C., preferably at temperatures of from 0° C. to 80° C.

For carrying out the process (a) according to the invention for preparing the compounds of the formula (I), in general from 0.8 to 15 mol, preferably from 0.8 to 8 mol, of aniline derivative of the formula (III) are employed per mole of the difluoromethylbenzoyl derivative of the formula (II).

For carrying out the process (j) according to the invention for preparing the compounds of the formula (IV), in general from 0.8 to 15 mol, preferably from 0.8 to 8 mol, of haloaniline of the formula (XIII) are employed per mole of the difluoromethylbenzoyl derivative of the formula (II).

For carrying out the process (k) according to the invention for preparing the compounds of the formula (VI), in general from 0.8 to 15 mol, preferably from 0.8 to 8 mol, of anilineboronic acid derivative of the formula (XIV) are employed per mole of the difluoromethylbenzoyl derivative of the formula (II).

For carrying out the process (l) according to the invention for preparing the compounds of the formula (VIII), in general from 0.8 to 15 mol, preferably from 0.8 to 8 mol, of hydroxyalkylaniline derivative of the formula (XV) are employed per mole of the difluoromethylbenzoyl derivative of the formula (II)

For carrying out the process (m) according to the invention for preparing the compounds of the formula (IX), in general from 0.8 to 15 mol, preferably from 0.8 to 8 mol, of ketoaniline of the formula (XVI) are employed per mole of the difluoromethylbenzoyl derivative of the formula (II).

Suitable diluents for carrying out the processes (b), (c) and (d) according to the invention are all inert organic solvents. These preferably include aliphatic, alicyclic or aromatic hydrocarbons, such as, for example, petroleum ether, hexane, heptane, cyclohexane, methylcyclohexane, benzene, toluene, xylene or decalin; ethers, such as diethyl ether, diisopropyl ether, methyl tert-butyl ether, methyl tert-amyl ether, dioxane, tetrahydrofuran, 1,2-dimethoxyethane, 1,2-diethoxyethane or anisole; nitrites, such as acetonitrile, propionitrile, n- or iso-butyronitrile or benzonitrile; amides, such as N,N-dimethylformamide, N,N-dimethylacetamide, N-methylformanilide, N-methylpyrrolidone or hexamethylphosphoric triamide; esters, such as methyl acetate or ethyl acetate; sulfoxides, such as dimethyl sulfoxide; sulfones, such as sulfolane; alcohols, such as methanol, ethanol, n- or iso-propanol, n-, iso-, sec- or tert-butanol, ethanediol, propane-1,2-diol, ethoxyethanol, methoxyethanol, diethylene glycol monomethyl ether, diethylene glycol monoethyl ether, mixtures thereof with water or pure water.

When carrying out the processes (b), (c) and (d) according to the invention, the reaction temperatures can be varied within a relatively wide range. In general, the processes are carried out at temperatures of from 0° C. to 180° C., preferably at temperatures of from 20° C. to 150° C.

The processes (b), (c) and (d) according to the invention are, if appropriate, carried out in the presence of a suitable acid acceptor. Suitable acid acceptors are all customary inorganic or organic bases. These preferably include alkaline earth metal or alkali metal hydrides, hydroxides, amides, alkoxides, acetates, fluorides, phosphates, carbonates or bicarbonates, such as, for example, sodium hydride, sodium amide, lithium diisopropylamide, sodium methoxide, sodium ethoxide, potassium tert-butoxide, sodium hydroxide, potassium hydroxide, sodium acetate, sodium phosphate, potassium phosphate, potassium fluoride, cesium fluoride, sodium carbonate, potassium carbonate, potassium bicarbonate, sodium bicarbonate or cesium carbonate, and also tertiary amines, such as trimethylamine, triethylamine, tributylamine, N,N-dimethylaniline, N,N-dimethylbenzylamine, pyridine, N-methylpiperidine, N-methylmorpholine, N,N-dimethylaminopyridine, diazabicyclooctane (DABCO), diazabicyclononene (DBN) or diazabicycloundecene (DBU).

The processes (b), (c) and (d) according to the invention are carried out in the presence of a catalyst, such as, for example, a palladium salt or complex. Suitable catalysts are, preferably, palladium chloride, palladium acetate, tetrakis(triphenylphosphine)palladium, bis-(triphenylphosphine)palladiumdichloride or 1,1′-bis(diphenylphosphino)ferrocenepalladium(II) chloride.

It is also possible to generate a palladium complex in the reaction mixture by separately adding a palladium salt and a complex ligand, such as, for example, triethylphosphine, tri-tert-butylphosphine, tricyclohexylphosphine, 2-dicyclohexylphosphine)biphenyl, 2-di-tert-butylphosphine)biphenyl, 2-(dicyclohexylphosphine)-2′-(N,N-dimethylamino)biphenyl, triphenylphosphine, tris(o-tolyl)phosphine, sodium 3-(diphenylphosphino)benzenesulfonate, tris-2-methoxyphenyl)phosphine, 2,2′-bis(diphenylphosphine)-1,1′-binaphthyl, 1,4-bis(diphenylphosphine)butane, 1,2-bis(diphenylphosphine)ethane, 1,4-bis(dicyclohexylphosphine)butane, 1,2-bis(dicyclohexylphosphine)ethane, 2-dicyclohexylphosphine)2′-(N,N-dimethylamino)biphenyl, bis(diphenylphosphino)ferrocene or tris-(2,4-tert-butylphenyl)phosphite to the reaction.

To carry out the process (b) according to the invention for preparing the compounds of the formula (I), in general from 1 to 15 mol, preferably from 2 to 8 mol, of the boronic acid derivative of the formula (V) are employed per mole of the halodifluoromethylbenzanilide of the formula (IV).

To carry out the process (c) according to the invention for preparing the compounds of the formula (I), in general from 0.8 to 15 mol, preferably from 0.8 to 8 mol, of the phenyl derivative of the formula (VII) are employed per mole of the difluoromethylbenzamideboronic acid derivative of the formula (VI).

To carry out the process (d) according to the invention for preparing the compounds of the formula (I), in general from 0.8 to 15 mol, preferably from 0.8 to 8 mol, of the phenyl derivative of the formula (VII) and from 0.8 to 15 mol, preferably from 0.8 to 8 mol, of 4,4,4′,4′,5,5,5′,5′-octamethyl-2,2′-bis-1,3,2-dioxaborolane are employed per mole of the halodifluoromethylbenzanilide of the formula (IV).

Suitable diluents for carrying out the process (e) according to the invention are all inert organic solvents. These preferably include aliphatic or alicyclic hydrocarbons, such as, for example, petroleum ether, hexane, heptane, cyclohexane, methylcyclohexane or decalin; ethers, such as diethyl ether, diisopropyl ether, methyl tert-butyl ether, methyl tert-amyl ether, dioxane, tetrahydrofuran, 1,2-dimethoxyethane or 1,2-diethoxyethane; alcohols, such as methanol, ethanol, n- or iso-propanol, n-, iso-, sec- or tert-butanol, ethanediol, propane-1,2-diol, ethoxyethanol, methoxyethanol, diethylene glycol monomethyl ether, diethylene glycol monoethyl ether, mixtures thereof with water or pure water.

The (e) process according to the invention is carried out in the presence of a catalyst. Suitable catalysts are all those commonly employed for hydrogenations. Examples which may be mentioned are: Raney nickel, palladium and platinum, if appropriate on a support, such as, for example, activated carbon.

Instead of in the presence of hydrogen in combination with a catalyst, the hydrogenation in the process (e) according to the invention can also be carried out in the presence of triethylsilane.

When carrying out the process (e) according to the invention, the reaction temperatures can be varied within a relatively wide range. In general, the reaction is carried out at temperatures of from 0° C. to 150° C., preferably at temperatures of from 20° C. to 100° C.

The process (e) according to the invention is carried out under a hydrogen pressure between 0.5 and 200 bar, preferably between 2 and 50 bar, particularly preferably between 3 and 10 bar.

Suitable diluents for carrying out the process (f) according to the invention are all inert organic solvents. These preferably include aliphatic, alicyclic or aromatic hydrocarbons, such as, for example, petroleum ether, hexane, heptane, cyclohexane, methylcyclohexane, benzene, toluene, xylene or decalin; halogenated hydrocarbons, such as, for example, chlorobenzene, dichlorobenzene, dichloromethane, chloroform, carbon tetrachloride, dichloroethane or trichloroethane; ethers, such as diethyl ether, diisopropyl ether, methyl tert-butyl ether, methyl tert-amyl ether, dioxane, tetrahydrofuran, 1,2-dimethoxyethane, 1,2-diethoxyethane or anisole; ketones, such as acetone, butanone, methyl isobutyl ketone or cyclohexanone; nitriles, such as acetonitrile, propionitrile, n- or iso-butyronitrile or benzonitrile; amides, such as N,N-dimethylformamide, N,N-dimethylacetamide, N-methylformanilide, N-methylpyrrolidone or hexamethylphosphoric triamide; esters, such as methyl acetate or ethyl acetate; sulfoxides, such as dimethyl sulfoxide; sulfones, such as sulfolane; alcohols, such as methanol, ethanol, n- or iso-propanol, n-, iso-, sec- or tert-butanol, ethanediol, propane-1,2-diol, ethoxyethanol, methoxyethanol, diethylene glycol monomethyl ether, diethylene glycol monoethyl ether, mixtures thereof with water or pure water.

The process (f) according to the invention is, if appropriate, carried out in the presence of an acid. Suitable acids are all inorganic and organic protic and Lewis acids, and also all polymeric acids. These include, for example, hydrogen chloride, sulfuric acid, phosphoric acid, formic acid, acetic acid, trifluoroacetic acid, methanesulfonic acid, trifluoromethanesulfonic acid, toluenesulfonic acid, boron trifluoride (also as etherate), boron tribromide, aluminum trichloride, titanium tetrachloride, tetrabutyl orthotitanate, zinc chloride, iron(III) chloride, antimony pentachloride, acidic ion exchangers, acidic aluminas and acidic silica gels.

When carrying out the process (f) according to the invention, the reaction temperatures can be varied within a relatively wide range. In general, the process is carried out at temperatures of from 0° C. to 150° C., preferably at temperatures of from 0° C. to 100° C.

The processes (f) and (e) according to the invention can also be carried out in a tandem reaction (“one-pot reaction”). To this end, a compound of the formula (VIII) is reacted, if appropriate in the presence of a diluent (suitable diluents as for process (f)), if appropriate in the presence of an acid (suitable acids as for process (f)) and in the presence of triethylsilane.

Suitable diluents for carrying out the process (g) according to the invention are all inert organic solvents. These preferably include nitriles, such as acetonitrile, propionitrile, n- or iso-butyronitrile or benzonitrile, or amides, such as N,N-dimethylformamide, N,N-dimethylacetamide, N-methylformanilide, N-methylpyrrolidone or hexamethylphosphoric triamide.

The process (g) according to the invention is, if appropriate, carried out in the presence of a suitable acid acceptor. Suitable acid acceptors are all customary inorganic or organic bases. These preferably include alkaline earth metal or alkali metal hydrides, hydroxides, amides, alkoxides, acetates, carbonates or bicarbonates, such as, for example, sodium hydride, sodium amide, sodium methoxide, sodium ethoxide, potassium tert-butoxide, sodium hydroxide, potassium hydroxide, ammonium hydroxide, sodium acetate, potassium acetate, calcium acetate, ammonium acetate, sodium carbonate, potassium carbonate, potassium bicarbonate, sodium bicarbonate or ammonium carbonate, and also tertiary amines, such as trimethylamine, triethylamine, tributylamine, N,N-dimethylaniline, N,N-dimethylbenzylamine, pyridine, N-methylpiperidine, N-methylmorpholine, N,N-dimethylaminopyridine, diazabicyclooctane (DABCO), diazabicyclononene (DBN) or diazabicycloundecene (DBU).

The process (g) according to the invention is carried out in the presence of one or more catalysts.

Suitable catalysts are in particular palladium salts or complexes. These are preferably palladium chloride, palladium acetate, tetrakis(triphenylphosphine)palladium or bis-(triphenylphosphine)palladium dichloride. It is also possible to generate a palladium complex in the reaction mixture by adding a palladium salt and a complex ligand separately to the reaction.

Preferred ligands are organophosphorus compounds. Examples which may be mentioned are: triphenylphosphine, tri-o-tolylphosphine, 2,2′-bis(diphenylphosphino)-1,1′-binaphthyl, dicyclohexylphosphinebiphenyl, 1,4-bis(diphenylphosphino)butane, bisdiphenylphosphinoferrocene, di-(tert-butylphosphino)biphenyl, di(cyclohexylphosphino)biphenyl, 2-dicyclohexylphosphino-2′-N,N-dimethylaminobiphenyl, tricyclohexylphosphine, tri-tert-butylphosphine. However, ligands may also be dispensed with.

Furthermore, the process (g) according to the invention is, if appropriate, carried out in the presence of a further metal salt, such as a copper salt, for example copper (I) iodide.

When carrying out the process (g) according to the invention, the reaction temperatures can be varied within a relatively wide range. In general, the process is carried out at temperatures of from 20° C. to 180° C., preferably at temperatures of from 50° C. to 150° C.

For carrying out the process (g) according to the invention for preparing the compounds of the formula (I), in general from 1 to 5 mol, preferably from 1 to 2 mol, of the alkyne of the formula (IX) or the alkene of the formula (X) are employed per mole of the halodifluoromethylbenzanilide of the formula (IV).

Suitable diluents for carrying out the process (h) according to the invention are all inert organic solvents. These preferably include aliphatic, alicyclic or aromatic hydrocarbons, such as, for example, petroleum ether, hexane, heptane, cyclohexane, methylcyclohexane, benzene, toluene, xylene or decalin; halogenated hydrocarbons, such as, for example, chlorobenzene, dichlorobenzene, dichloromethane, chloroform, carbon tetrachloride, dichloroethane or trichloroethane; ethers, such as diethyl ether, diisopropyl ether, methyl tert-butyl ether, methyl tert-amyl ether, dioxane, tetrahydrofuran, 1,2-dimethoxyethane, 1,2-diethoxyethane or anisole; nitriles, such as acetonitrile, propionitrile, n- or iso-butyronitrile or benzonitrile; amides, such as N,N-dimethylformamide, N,N-dimethylacetamide, N-methylformanilide, N-methylpyrrolidone or hexamethylphosphoric triamide; esters, such as methyl acetate or ethyl acetate; sulfoxides, such as dimethylsulfoxide; sulfones, such as sulfolane; alcohols, such as methanol, ethanol, n- or iso-propanol, n-, iso-, sec- or tert-butanol, ethanediol, propane-1,2-diol, ethoxyethanol, methoxyethanol, diethylene glycol monomethyl ether, diethylene glycol monoethyl ether.

The process (h) according to the invention is, if appropriate, carried out in the presence of a suitable acid acceptor. Suitable acid acceptors are all customary strong bases. These preferably include alkaline earth metal or alkali metal hydrides, hydroxides, amides, alkoxides or alkali metal hydrocarbon compounds, such as, for example, sodium hydride, sodium hydroxide, potassium hydroxide, sodium amide, lithium diisopropylamide, sodium methoxide, sodium ethoxide, potassium tert-butoxide, methylithium, phenyllithium or butyllithium.

When carrying out the process (h) according to the invention, the reaction temperatures can be varied within a relatively wide range. In general, the process is carried out at temperatures of from −80° C. to 150° C., preferably at temperatures of from −30° C. to 80° C.

To carry out the process (h) according to the invention for preparing compounds of the formula (I), in general from 1 to 5 mol, preferably from 1 to 2 mol, of the phosphorus compound of the formula (XII) are employed per mole of the ketone of the formula (XI).

Suitable diluents for carrying out the process (i) according to the invention are all inert organic solvents. These preferably include aliphatic, alicyclic or aromatic hydrocarbons, such as, for example, petroleum ether, hexane, heptane, cyclohexane, methylcyclohexane, benzene, toluene, xylene or decalin; halogenated hydrocarbons, such as, for example, chlorobenzene, dichlorobenzene, dichloromethane, chloroform, carbon tetrachloride, dichloroethane or trichloroethane; ethers, such as diethyl ether, diisopropyl ether, methyl tert-butyl ether, methyl tert-amyl ether, dioxane, tetrahydrofuran, 1,2-dimethoxyethane, 1,2-diethoxyethane or anisole; or amides, such as N,N-dimethylformamide, N,N-dimethylacetamide, N-methylformanilide, N-methylpyrrolidone or hexamethylphosphoric triamide.

The process (i) according to the invention is carried out in the presence of a base. Suitable bases are all customary inorganic or organic bases. These preferably include alkaline earth metal or alkali metal hydrides, hydroxides, amides, alkoxides, acetates, carbonates or bicarbonates, such as, for example, sodium hydride, sodium amide, sodium methoxide, sodium ethoxide, potassium tert-butoxide, sodium hydroxide, potassium hydroxide, ammonium hydroxide, sodium acetate, potassium acetate, calcium acetate, ammonium acetate, sodium carbonate, potassium carbonate, potassium bicarbonate, sodium bicarbonate or cesium carbonate, and also tertiary amines, such as trimethylamine, triethylamine, tributylamine, N,N-dimethylaniline, N,N-dimethylbenzylamine, pyridine, N-methylpiperidine, N-methylmorpholine, N,N-dimethylaminopyridine, diazabicyclooctane (DABCO), diazabicyclononene (DBN) or diazabicycloundecene (DBU).

When carrying out the process (i) according to the invention, the reaction temperatures can be varied within a relatively wide range. In general, the process is carried out at temperatures of from 0° C. to 150° C., preferably at temperatures of from 20° C. to 110° C.

To carry out the process (i) according to the invention for preparing the compounds of the formula (I), in general from 0.2 to 5 mol, preferably from 0.5 to 2 mol, of the halide of the formula (XIII) are employed per mole of the iodopyrazolylcarboxanilide of the formula (Ib).

All processes according to the invention are generally carried out under atmospheric pressure. However, it is also possible to operate under elevated or reduced pressure—in general between 0.1 bar and 10 bar.

The compounds according to the invention have potent microbicidal activity and can be employed for controlling undesirable microorganisms, such as fungi and bacteria, in crop protection and in the protection of materials.

Fungicides can be employed in crop protection for controlling Plasmodiophoromycetes, Oomycetes, Chytridiomycetes, Zygomycetes, Ascomycetes, Basidiomycetes and Deuteromycetes.

Bactericides can be employed in crop protection for controlling Pseudomonadaceae, Rhizobiaceae, Enterobacteriaceae, Corynebacteriaceae and Streptomycetaceae.

Some pathogens causing fungal and bacterial diseases which come under the generic names listed above may be mentioned as examples, but not by way of limitation:
Xanthomonas species, such as, for example, Xanthomonas campestris pv. oryzae;
Pseudomonas species, such as, for example, Pseudomonas syringae pv. lachrymans;
Erwinia species, such as, for example, Erwinia amylovora;
Pythium species, such as, for example, Pythium ultimum;
Phytophthora species, such as, for example, Phytophthora infestans;
Pseudoperonospora species, such as, for example, Pseudoperonospora humuli or Pseudoperonospora cubensis;
Plasmopara species, such as, for example, Plasmopara viticola;
Bremia species, such as, for example, Bremia lactucae;
Peronospora species, such as, for example, Peronospora pisi or P. brassicae;
Erysiphe species, such as, for example, Erysiphe graminis;
Sphaerotheca species, such as, for example, Sphaerotheca fuliginea;
Podosphaera species, such as, for example, Podosphaera leucotricha;
Venturia species, such as, for example, Venturia inaequalis;
Pyrenophora species, such as, for example, Pyrenophora teres or P. graminea (conidia form: Drechslera, syn: Helminthosporium);
Cochliobolus species, such as, for example, Cochliobolus sativus (conidia form: Drechslera, syn: Helminthosporium);
Cochliobolus species, such as, for example, Cochliobolus sativus (conidia form: Drechslera, Syn: Helminthosporium);
Uromyces species, such as, for example, Uromyces appendiculatus;
Puccinia species, such as, for example, Puccinia recondita;
Sclerotinia species, such as, for example, Sclerotinia sclerotiorum;
Tilletia species, such as, for example, Tilletia caries;
Ustilago species, such as, for example, Ustilago nuda or Ustilago avenae;
Pellicularia species, such as, for example, Pellicularia sasakii;
Pyricularia species, such as, for example, Pyricularia oryzae;
Fusarium species, such as, for example, Fusarium culmorum;
Botrytis species, such as, for example, Botrytis cinerea;
Septoria species, such as, for example, Septoria nodorum;
Leptosphaeria species, such as, for example, Leptosphaeria nodorum;
Cercospora species, such as, for example, Cercospora canescens;
Alternaria species, such as, for example, Alternaria brassicae;
Pseudocercosporella species, such as, for example, Pseudocercosporella herpotrichoides.

The active compounds according to the invention also have very good fortifying action in plants. Accordingly, they can be used for mobilizing the defenses of the plant against attack by undesirable microorganisms.

In the present context, plant-fortifying (resistance-inducing) substances are to be understood as meaning those substances which are capable of stimulating the defense system of plants such that, when the treated plants are subsequently inoculated with undesirable microorganisms, they show substantial resistance to these microorganisms.

In the present case, undesirable microorganisms are to be understood as meaning phytopathogenic fungi, bacteria and viruses. Accordingly, the substances according to the invention can be used to protect plants for a certain period after the treatment against attack by the pathogens mentioned. The period for which protection is provided generally extends over 1 to 10 days, preferably 1 to 7 days, after the treatment of the plants with the active compounds.

The fact that the active compounds are well tolerated by plants at the concentrations required for controlling plant diseases permits the treatment of above-ground parts of plants, of propagation stock and seeds, and of the soil.

The active compounds according to the invention can be used with particularly good results for controlling cereal diseases, such as, for example, against Puccinia species, diseases in viticulture and in the cultivation of fruit and vegetables, such as, for example, against Botrytis, Venturia or Alternaria species.

The active compounds according to the invention are also suitable for increasing the yield of crops. In addition, they show reduced toxicity and are well tolerated by plants.

At certain concentrations and application rates, the active compounds according to the invention can also if appropriate be used as herbicides, for influencing plant growth and for controlling animal pests. If appropriate, they can also be used as intermediates and precursors for the synthesis of further active compounds.

All plants and plant parts can be treated in accordance with the invention. Plants are to be understood as meaning in the present context all plants and plant populations such as desired and undesired wild plants or crop plants (including naturally occurring crop plants). Crop plants can be plants which can be obtained by conventional plant breeding and optimization methods or by biotechnological and recombinant methods or by combinations of these methods, including the transgenic plants and inclusive of the plant cultivars protectable or not protectable by plant breeders' rights. Plant parts are to be understood as meaning all parts and organs of plants above and below the ground, such as shoot, leaf, flower and root, examples which may be mentioned being leaves, needles, stalks, stems, flowers, fruit bodies, fruits, seeds, roots, tubers and rhizomes. The plant parts also include harvested material, and vegetative and generative propagation material, for example cuttings, tubers, rhizomes, offshoots and seeds.

Treatment according to the invention of the plants and plant parts with the active compounds is carried out directly or by allowing the compounds to act on their surroundings, environment or storage space by the customary treatment methods, for example by immersion, spraying, evaporation, fogging, scattering, painting on, and, in the case of propagation material, in particular in the case of seeds, also by applying one or more coats.

In the protection of materials, the substances according to the invention can be employed for protecting industrial materials against infection with, and destruction by, undesired microorganisms.

Industrial materials in the present context are understood as meaning nonliving materials which have been prepared for use in industry. For example, industrial materials which are intended to be protected by active compounds according to the invention from microbial change or destruction can be adhesives, sizes, paper and board, textiles, leather, wood, paints and plastic articles, cooling lubricants and other materials which can be infected with, or destroyed by, microorganisms. Parts of production plants, for example cooling-water circuits, which may be impaired by the proliferation of microorganisms may also be mentioned within the scope of the materials to be protected. Industrial materials which may be mentioned within the scope of the present invention are preferably adhesives, sizes, paper and board, leather, wood, paints, cooling lubricants and heat-transfer liquids, particularly preferably wood.

Microorganisms capable of degrading or changing the industrial materials which may be mentioned are, for example, bacteria, fungi, yeasts, algae and slime organisms. The active compounds according to the invention preferably act against fungi, in particular molds, wood-discoloring and wood-destroying fungi (Basidiomycetes), and against slime organisms and algae.

Microorganisms of the following genera may be mentioned as examples:
Alternaria, such as Alternaria tenuis,
Aspergillus, such as Aspergillus niger,
Chaetomium, such as Chaetomium globosum,
Coniophora, such as Coniophora puetana,
Lentinus, such as Lentinus tigrinus,
Penicillium, such as Penicillium glaucum,
Polyporus, such as Polyporus versicolor,
Aureobasidium, such as Aureobasidium pullulans,
Sclerophoma, such as Sclerophoma pityophila,
Trichoderma, such as Trichoderma viride,
Escherichia, such as Escherichia coli,
Pseudomonas, such as Pseudomonas aeruginosa, and
Staphylococcus, such as Staphylococcus aureus.

Depending on their particular physical and/or chemical properties, the active compounds can be converted to the customary formulations, such as solutions, emulsions, suspensions, powders, foams, pastes, granules, aerosols and microencapsulations in polymeric substances and in coating compositions for seeds, and ULV cool and warm fogging formulations.

These formulations are produced in a known manner, for example by mixing the active compounds with extenders, that is, liquid solvents, liquefied gases under pressure, and/or solid carriers, optionally with the use of surfactants, that is emulsifiers and/or dispersants, and/or foam formers. If the extender used is water, it is also possible to employ, for example, organic solvents as auxiliary solvents. Essentially, suitable liquid solvents are: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example petroleum fractions, alcohols such as butanol or glycol and their ethers and esters, ketones such as acetone, methyl ethyl ketone, methyl isobutyl ketone or cyclohexanone, strongly polar solvents such as dimethylformamide or dimethyl sulfoxide, or else water. Liquefied gaseous extenders or carriers are to be understood as meaning liquids which are gaseous at standard temperature and under atmospheric pressure, for example aerosol propellants such as halogenated hydrocarbons, or else butane, propane, nitrogen and carbon dioxide. Suitable solid carriers are: for example ground natural minerals such as kaolins, clays, talc, chalk, quartz, attapulgite, montmorillonite or diatomaceous earth, and ground synthetic minerals such as finely divided silica, alumina and silicates. Suitable solid carriers for granules are: for example crushed and fractionated natural rocks such as calcite, marble, pumice, sepiolite and dolomite, or else synthetic granules of inorganic and organic meals, and granules of organic material such as sawdust, coconut shells, corn cobs and tobacco stalks. Suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulfonates, alkyl sulfates, arylsulfonates, or else protein hydrolyzates. Suitable dispersants are: for example lignosulfite waste liquors and methylcellulose.

Tackifiers such as carboxymethylcellulose and natural and synthetic polymers in the form of powders, granules or latices, such as gum arabic, polyvinyl alcohol and polyvinyl acetate, or else natural phospholipids such as cephalins and lecithins and synthetic phospholipids can be used in the formulations. Other possible additives are mineral and vegetable oils.

It is possible to use colorants such as inorganic pigments, for example iron oxide, titanium oxide and Prussian Blue, and organic dyestuffs such as alizarin dyestuffs, azo dyestuffs and metal phthalocyanine dyestuffs, and trace nutrients such as salts of iron, manganese, boron, copper, cobalt, molybdenum and zinc.

The formulations generally comprise between 0.1 and 95 percent by weight of active compound, preferably between 0.5 and 90%.

The active compounds according to the invention can be used as such or in their formulations, also in a mixture with known fungicides, bactericides, acaricides, nematicides or insecticides, to broaden, for example, the activity spectrum or to prevent development of resistance. In many cases, synergistic effects are obtained, i.e. the activity of the mixture is greater than the activity of the individual components.

Examples of suitable mixing components are the following compounds:

Fungicides:

2-phenylphenol; 8-hydroxyquinoline sulfate; acibenzolar-S-methyl; aldimorph; amidoflumet; ampropylfos; ampropylfos-potassium; andoprim; anilazine; azaconazole; azoxystrobin; benalaxyl; benodanil; benomyl; benthiavalicarb-isopropyl; benzamacril; benzamacril-isobutyl; bilanafos; binapacryl; biphenyl; bitertanol; blasticidin-S; bromuconazole; bupirimate; buthiobate; butylamine; calcium polysulfide; capsimycin; captafol; captan; carbendazim; carboxin; carpropamid; carvone; chinomethionat; chlobenthiazone; chlorfenazole; chloroneb; chlorothalonil; chlozolinate; clozylacon; cyazofamid; cyflufenamid; cymoxanil; cyproconazole; cyprodinil; cyprofuram; Dagger G; debacarb; dichlofluanid; dichlone; dichlorophen; diclocymet; diclomezine; dicloran; diethofencarb; difenoconazole; diflumetorim; dimethirimol; dimethomorph; dimoxystrobin; diniconazole; diniconazole-M; dinocap; diphenylamine; dipyrithione; ditalimfos; dithianon; dodine; drazoxolon; edifenphos; epoxiconazole; ethaboxam; ethirimol; etridiazole; famoxadone; fenamidone; fenapanil; fenarimol; fenbuconazole; fenfuram; fenhexamid; fenitropan; fenoxanil; fenpiclonil; fenpropidin; fenpropimorph; ferbam; fluazinam; flubenzimine; fludioxonil; flumetover; flumorph; fluoromide; fluoxastrobin; fluquinconazole; flurprimidol; flusilazole; flusulfamide; flutolanil; flutriafol; folpet; fosetyl-Al; fosetyl-sodium; fuberidazole; furalaxyl; furametpyr; furcarbanil; furmecyclox; guazatine; hexachlorobenzene; hexaconazole; hymexazole; imazalil; imibenconazole; iminoctadine triacetate; iminoctadine tris(albesil); iodocarb; ipconazole; iprobenfos; iprodione; iprovalicarb; irumamycin; isoprothiolane; isovaledione; kasugamycin; kresoxim-methyl; mancozeb; maneb; meferimzone; mepanipyrim; mepronil; metalaxyl; metalaxyl-M; metconazole; methasulfocarb; methfuroxam; metiram; metominostrobin; metsulfovax; mildiomycin; myclobutanil; myclozolin; natamycin; nicobifen; nitrothal-isopropyl; noviflumuron; nuarimol; ofurace; orysastrobin; oxadixyl; oxolinic acid; oxpoconazole; oxycarboxin; oxyfenthiin; paclobutrazole; pefurazoate; penconazole; pencycuron; phosdiphen; phthalide; picoxystrobin; piperalin; polyoxins; polyoxorim; probenazole; prochloraz; procymidone; propamocarb; propanosine-sodium; propiconazole; propineb; proquinazid; prothioconazole; pyraclostrobin; pyrazophos; pyrifenox; pyrimethanil; pyroquilon; pyroxyfur; pyrrolenitrine; quinconazole; quinoxyfen; quintozene; simeconazole; spiroxamine; sulfur; tebuconazole; tecloftalam; tecnazene; tetcyclacis; tetraconazole; thiabendazole; thicyofen; thifluzamide; thiophanate-methyl; thiram; tioxymid; tolclofos-methyl; tolylfluanid; triadimefon; triadimenol; triazbutil; triazoxide; tricyclamide; tricyclazole; tridemorph; trifloxystrobin; triflumizole; triforine; triticonazole; uniconazole; validamycin A; vinclozolin; zineb; ziram; zoxamide; (2S)-N-[2-[4-[[3-(4-chlorophenyl)-2-propynyl]oxy]-3-methoxyphenyl]ethyl]-3-methyl-2-[(methylsulfonyl)amino]butanamide; 1-(1-naphthalenyl)-1H-pyrrole-2,5-dione; 2,3,5,6-tetrachloro-4-(methylsulfonyl)pyridine; 2-amino-4-methyl-N-phenyl-5-thiazolecarboxamide; 2-chloro-N-(2,3-dihydro-1,1,3-trimethyl-1H-inden-4-yl)-3-pyridinecarboxamide; 3,4,5-trichloro-2,6-pyridinedicarbonitrile; actinovate; cis-1-(4-chlorophenyl)-2-(1H-1,2,4-triazol-1-yl)cycloheptanol; methyl 1-(2,3-dihydro-2,2-dimethyl-1H-inden-1-yl)-1H-imidazole-5-carboxylate; monopotassium carbonate; N-(6-methoxy-3-pyridinyl)cyclopropanecarboxamide; N-butyl-8-(1,1-dimethylethyl)-1-oxaspiro[4.5]decane-3-amine; sodium tetrathiocarbonate; and copper salts and preparations, such as Bordeaux mixture; copper hydroxide; copper naphthenate; copper oxychloride; copper sulfate; cufraneb; cuprous oxide; mancopper; oxine-copper.

Bactericides:

bronopol, dichlorophen, nitrapyrin, nickel dimethyldithiocarbamate, kasugamycin, octhilinone, furancarboxylic acid, oxytetracyclin, probenazole, streptomycin, tecloftalam, copper sulfate and other copper preparations.

Insecticides/acaricides/nematicides:

abamectin, ABG-9008, acephate, acequinocyl, acetamiprid, acetoprole, acrinathrin, AKD-1022, AKD-3059, AKD-3088, alanycarb, aldicarb, aldoxycarb, allethrin, allethrin 1R-isomers, alpha-cypermethrin (alphamethrin), amidoflumet, aminocarb, amitraz, avermectin, AZ-60541, azadirachtin, azamethiphos, azinphos-methyl, azinphos-ethyl, azocyclotin, Bacillus popilliae, Bacillus sphaericus, Bacillus subtilis, Bacillus thuringiensis, Bacillus thuringiensis strain EG-2348, Bacillus thuringiensis strain GC-91, Bacillus thuringiensis strain NCTC-11821, baculoviruses, Beauveria bassiana, Beauveria tenella, bendiocarb, benfuracarb, bensultap, benzoximate, beta-cyfluthrin, beta-cypermethrin, bifenazate, bifenthrin, binapacryl, bioallethrin, bioallethrin-S-cyclopentyl-isomer, bioethanomethrin, biopermethrin, bioresmethrin, bistrifluron, BPMC, brofenprox, bromophos-ethyl, bromopropylate, bromfenvinfos (-methyl), BTG-504, BTG-505, bufencarb, buprofezin, butathiofos, butocarboxim, butoxycarboxim, butylpyridaben, cadusafos, camphechlor, carbaryl, carbofuran, carbophenothion, carbosulfan, cartap, CGA-50439, chinomethionat, chlordane, chlordimeform, chloethocarb, chlorethoxyfos, chlorfenapyr, chlorfenvinphos, chlorfluazuron, chlormephos, chlorobenzilate, chloropicrin, chlorproxyfen, chlorpyrifos-methyl, chlorpyrifos (-ethyl), chlovapor-thrin, chromafenozide, cis-cypermethrin, cis-resmethrin, cis-permethrin, clocythrin, cloethocarb, clofentezine, clothianidin, clothiazoben, codlemone, coumaphos, cyanofenphos, cyanophos, cycloprene, cycloprothrin, Cydia pomonella, cyfluthrin, cyhalothrin, cyhexatin, cypermethrin, cyphenothrin (1R-trans-isomer), cyromazine, DDT, deltamethrin, demeton-S-methyl, demeton-S-methylsulfone, diafenthiuron, dialifos, diazinon, dichlofenthion, dichlorvos, dicofol, dicrotophos, dicyclanil, diflubenzuron, dimethoate, dimethylvinphos, dinobuton, dinocap, dinotefuran, diofenolan, disulfoton, docusat-sodium, dofenapyn, DOWCO439, eflusilanate, emamectin, emamectin-benzoate, empenthrin (1R-isomer), endosulfan, Entomopthora spp., EPN, esfenvalerate, ethiofencarb, ethiprole, ethion, ethoprophos, etofenprox, etoxazole, etrimfos, famphur, fenamiphos, fenazaquin, fenbutatin oxide, fenfluthrin, fenitrothion, fenobucarb, fenothiocarb, fenoxacrim, fenoxycarb, fenpropathrin, fenpyrad, fenpyrithrin, fenpyroximate, fensulfothion, fenthion, fentrifanil, fenvalerate, fipronil, flonicamid, fluacrypyrim, fluazuron, flubenzimine, flubrocythrinate, flucycloxuron, flucythrinate, flufenerim, flufenoxuron, flufenprox, flumethrin, flupyrazofos, flutenzin (flufenzine), fluvalinate, fonofos, formetanate, formothion, fosmethilan, fosthiazate, fubfenprox (fluproxyfen), furathiocarb, gamma-HCH, gossyplure, grandlure, granulosis viruses, halfenprox, halofenozide, HCH, HCN-801, heptenophos, hexaflumuron, hexythiazox, hydramethylnone, hydroprene, IKA-2002, imidacloprid, imiprothrin, indoxacarb, iodofenphos, iprobenfos, isazofos, isofenphos, isoprocarb, isoxathion, ivermectin, japonilure, kadethrin, nuclear polyhedrosis viruses, kinoprene, lambda-cyhalothrin, lindane, lufenuron, malathion, mecarbam, mesulfenfos, metaldehyde, metam-sodium, methacrifos, methamidophos, Metharhizium anisopliae, Metharhizium flavoviride, methidathion, methiocarb, methomyl, methoprene, methoxychlor, methoxyfenozide, metolcarb, metoxadiazone, mevinphos, milbemectin, milbemycin, MKI-245, MON-45700, monocrotophos, moxidectin, MT-800, naled, NC-104, NC-170, NC-184, NC-194, NC-196, niclosamide, nicotine, nitenpyram, nithiazine, NNI-0001, NNI-0101, NNI-0250, NNI-9768, novaluron, noviflumuron, OK-5101, OK-5201, OK-9601, OK-9602, OK-9701, OK-9802, omethoate, oxamyl, oxydemeton-methyl, Paecilomyces fumosoroseus, parathion-methyl, parathion (-ethyl), permethrin (cis-, trans-), petroleum, PH-6045, phenothrin (1R-trans isomer), phenthoate, phorate, phosalone, phosmet, phosphamidon, phosphocarb, phoxim, piperonyl butoxide, pirimicarb, pirimiphos-methyl, pirimiphos-ethyl, prallethrin, profenofos, promecarb, propaphos, propargite, propetamphos, propoxur, prothiofos, prothoate, protrifenbute, pymetrozine, pyraclofos, pyresmethrin, pyrethrum, pyridaben, pyridalyl, pyridaphenthion, pyridathion, pyrimidifen, pyriproxyfen, quinalphos, resmethrin, RH-5849, ribavirin, RU-12457, RU-15525, S421, S-1833, salithion, sebufos, SI-0009, silafluofen, spinosad, spirodiclofen, spiromesifen, sulfluramid, sulfotep, sulprofos, SZI-121, tau-fluvalinate, tebufenozide, tebufenpyrad, tebupirimfos, teflubenzuron, tefluthrin, temephos, temivinphos, terbam, terbufos, tetrachlorvinphos, tetradifon, tetramethrin, tetramethrin (1R-isomer), tetrasul, theta-cypermethrin, thiacloprid, thiamethoxam, thiapronil, thiatriphos, thiocyclam hydrogen oxalate, thiodicarb, thiofanox, thiometon, thiosultap-sodium, thuringiensin, tolfenpyrad, tralocythrin, tralomethrin, transfluthrin, triarathene, triazamate, triazophos, triazuron, trichlophenidine, trichlorfon, triflumuron, trimethacarb, vamidothion, vaniliprole, verbutin, Verticillium lecanii, WL-108477, WL-40027, YI-5201, YI-5301, YI-5302, XMC, xylylcarb, ZA-3274, zeta-cypermethrin, zolaprofos, ZXI-8901, the compound 3-methylphenyl propylcarbamate (tsumacide Z), the compound 3-(5-chloro-3-pyridinyl)-8-(2,2,2-trifluoroethyl)-8-azabicyclo[3.2.1]octane-3-carbonitrile (CAS-Reg. No. 185982-80-3) and the corresponding 3-endo-isomer (CAS-Reg. No. 185984-60-5) (cf. WO-96/37494, WO-98/25923), and also preparations which comprise insecticidally active plant extracts, nematodes, fungi or viruses.

A mixture with other known active compounds, such as herbicides, or with fertilizers and growth regulators, safeners or semiochemicals, is also possible.

In addition, the compounds of the formula (I) according to the invention also have very good antimycotic activity. They have a very broad antimycotic activity spectrum in particular against dermatophytes and yeasts, molds and diphasic fungi (for example against Candida species, such as Candida albicans, Candida glabrata), and Epidermophyton floccosum, Aspergillus species, such as Aspergillus niger and Aspergillus fumigatus, Trichophyton species, such as Trichophyton mentagrophytes, Microsporon species such as Microsporon canis and audouinii. The list of these fungi by no means limits the mycotic spectrum covered, but is only for illustration.

The active compounds can be used as such, in the form of their formulations or the use forms prepared therefrom, such as ready-to-use solutions, suspensions, wettable powders, pastes, soluble powders, dusts and granules. Application is carried out in a customary manner, for example by watering, spraying, atomizing, broadcasting, dusting, foaming, spreading, etc. It is furthermore possible to apply the active compounds by the ultra-low-volume method, or to inject the active compound preparation or the active compound itself into the soil. It is also possible to treat the seeds of the plants.

When using the active compounds according to the invention as fungicides, the application rates can be varied within a relatively wide range, depending on the kind of application. For the treatment of parts of plants, the active compound application rates are generally between 0.1 and 10 000 g/ha, preferably between 10 and 1000 g/ha. For seed dressing, the active compound application rates are generally between 0.001 and 50 g per kilogram of seed, preferably between 0.01 and 10 g per kilogram of seed. For the treatment of the soil, the active compound application rates are generally between 0.1 and 10 000 g/ha, preferably between 1 and 5000 g/ha.

As already mentioned above, it is possible to treat all plants or their parts in accordance with the invention. In a preferred embodiment, wild plant species or plant varieties and plant cultivars which have been obtained by traditional biological breeding methods, such as hybridization or protoplast fusion, and the parts of these varieties and cultivars are treated. In a further preferred embodiment, transgenic plants and plant cultivars which have been obtained by recombinant methods, if appropriate in combination with conventional methods (genetically modified organisms), and their parts are treated. The term “parts” or “parts of plants” or “plant parts” has been explained above.

Plants which are treated particularly preferably in accordance with the invention are those of the plant cultivars which are in each case commercially available or in use. Plant cultivars are understood as meaning plants with new traits which have been bred either by conventional breeding, by mutagenesis or by recombinant DNA techniques. They may take the form of cultivars, biotypes and genotypes.

Depending on the plant species or plant cultivars, their location and growth conditions (soils, climate, vegetation period, nutrition), the treatment according to the invention may also result in superadditive (“synergistic”) effects. Thus, for example, reduced application rates and/or a widened activity spectrum and/or an increase in the activity of the substances and compositions which can be used in accordance with the invention, better plant growth, increased tolerance to high or low temperatures, increased tolerance to drought or to salinity in the water or soil, increased flowering performance, facilitated harvesting, accelerated maturation, higher yields, higher quality and/or better nutritional value of the harvested products, better storage characteristics and/or processability of the harvested products are possible which exceed the effects which were actually to be expected.

The preferred transgenic plants or plant cultivars (those obtained by recombinant methods) to be treated in accordance with the invention include all those plants which, owing to the process of recombinant modification, were given genetic material which confers particular, advantageous, valuable traits to these plants. Examples of such properties are better plant growth, increased tolerance to high or low temperatures, increased tolerance to drought or to salinity in the water or soil, increased flowering performance, facilitated harvesting, accelerated maturation, higher yields, higher quality and/or higher nutritional value of the harvested products, better storage characteristics and/or better processability of the harvested products. Further examples of such traits, examples which must be mentioned especially, are better defense of the plants against animal and microbial pests, such as against insects, mites, phytopathogenic fungi, bacteria and/or viruses and an increased tolerance of the plants to certain herbicidal active compounds. Examples of transgenic plants which may be mentioned are the important crop plants, such as cereals (wheat, rice), corn, soybeans, potatoes, cotton, tobacco, oilseed rape and fruit plants (with the fruits apples, pears, citrus fruits and grapes), with particular emphasis on corn, soybeans, potatoes, cotton, tobacco, and oilseed rape. Traits which are especially emphasized are the increased defense of the plants against insects, arachnids, nematodes, and slugs and snails owing to toxins being formed in the plants, in particular toxins which are generated in the plants by the genetic material of Bacillus thuringiensis (for example by the genes CryIA(a), CryIA(b), CryIA(c), CryIIA, CryIIIA, CryIIIB2, Cry9c Cry2Ab, Cry3Bb and CryIF and their combinations; hereinbelow “Bt plants”). Other traits which are particularly emphasized are the increased defense of plants against fungi, bacteria and viruses by the systemic acquired resistance (SAR), systemin, phytoalexins, elicitors and resistance genes and correspondingly expressed proteins and toxins. Other traits which are especially emphasized are the increased tolerance of the plants to certain herbicidal active compounds, for example imidazolinones, sulfonylureas, glyphosate or phosphinotricin (for example “PAT” gene). The genes which confer the desired traits in each case may also be present in the transgenic plants in combination with one another. Examples of “Bt plants” which may be mentioned are corn cultivars, cotton cultivars, soybean cultivars and potato cultivars which are commercially available under the trade names YIELD GARD® (for example corn, cotton, soybean), KnockOut® (for example corn), StarLink® (for example corn), Bollgard® (cotton), Nucoton® (cotton) and NewLeaf® (potato). Examples of herbicide-tolerant plants which may be mentioned are corn cultivars, cotton cultivars and soybean cultivars which are commercially available under the trade names Roundup Ready® (tolerance to glyphosate, for example corn, cotton, soybean), Liberty Link® (tolerance to phosphinotricin, for example oilseed rape), IMI® (tolerance to imidazolinones) and STS® (tolerance to sulfonylureas, for example corn). Herbicide-resistant plants (plants bred in a conventional manner for herbicide tolerance) which may be mentioned include also the varieties commercially available under the name Clearfield® (for example corn). Naturally, these statements also apply to plant cultivars having these genetic traits or genetic traits still to be developed, which plant cultivars will be developed and/or marketed in the future.

The plants listed can be treated particularly advantageously according to the invention with the compounds of the general formula (I) or the active compound mixtures according to the invention. The preferred ranges stated above for the active compounds and mixtures also apply to the treatment of these plants. Particular emphasis may be given to the treatment of plants with the compounds or mixtures specifically mentioned in the present text.

The preparation and the use of the active compounds according to the invention is illustrated in the examples below.

### PREPARATION EXAMPLES

### Example 1

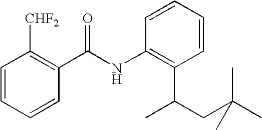

150 mg (0.87 mmol) of 2-difluoromethylbenzoic acid, 139 mg (0.73 mmol) of 2-(1,3,3-trimethyl-butyl)phenylamine, 188 mg (1.45 mmol) of N,N-diisopropylethylamine and 508 mg (1.09 mmol) of bromotripyrrolidinophosphonium hexafluorophosphate were stirred in 8 ml of acetonitrile at room temperature for 18 h. 10 ml of ethyl acetate/water 1:1 were added to the mixture, and the organic phase was separated off and washed with 10 ml of saturated ammonium chloride solution and then with 10 ml of water. Removal, concentration and drying of the organic phase gave 810 mg of crude product. Purification by column chromatography on silical gel 60 using a 10:1 mixture of petroleum ether/ethyl acetate to ethyl acetate afforded 250 mg (97.9% of theory) of 2-difluoromethyl-N-[2-(1,3,3-trimethylbutyl)phenyl]benzamide [log P (pH 2.3)=4.38].

The compounds of the formula (I) listed in table 1 below were also obtained analogously to example 1 and in accordance with the statements in the general description of the preparation processes (a) to (i) according to the invention:

TABLE 1

| | |
|---|---|
| | (I) |
| 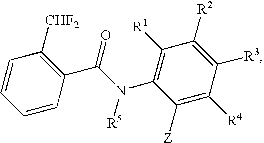 | |

| No. | Z | R⁵ | R⁴ | R³ | R² | R¹ | logP |
|---|---|---|---|---|---|---|---|
| 1 | 1,3,3-trimethylbutyl | H | H | H | H | H | 4.38 |
| 2 | 4-chloro-3-fluorophenyl | H | H | H | H | H | 3.67 |
| 3 | 3,4-dichlorophenyl | H | H | H | H | H | 3.96 |
| 4 | 4-chloro-2-methylphenyl | H | H | H | H | H | 4.06 |
| 5 | 1,3-dimethylbutyl | H | H | H | H | H | 4.11 |
| 6 | 4-propoxyiminomethylphenyl | H | H | H | H | H | 4.27 |
| 7 | 4-isopropoxyiminomethylphenyl | H | H | H | H | H | 4.24 |
| 8 | 3-chloro-4-trifluoromethylphenyl | H | H | H | H | H | 3.85 |

Preparation of the Starting Materials of the Formula (I)

### Example (II-1)

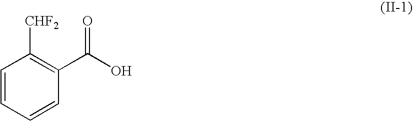 Step 1:

With stirring, a solution of 47.6 ml of DAST ([diethylamino]sulfur trifluoride) in 50 ml of dichloromethane was, at room temperature, added dropwise over a period of 2 hours to a solution of 45.0 g (343 mmol) of 2-formylbenzonitrile in 500 ml of dichloromethane. The reaction mixture was stirred for 16 hours.

For work-up, the solvent was evaporated and the residue was chromatographed. This gave 29.3 g (56% of theory) of 2-difluoromethylbenzonitril as a yellow oil (mass spectrometry: [M+1]=154).

Step 2:

A solution of 29.0 g (189 mmol) of 2-difluoromethylbenzonitrile in 700 ml 4% strength aqueous sodium hydroxide solution was heated under reflux for 6 hours. The reaction mixture was cooled to room temperature, poured onto ice and acidified with concentrated hydrochloric acid. The precipitate was filtered off and dried. This gave 19.3 g (58% of theory) of 2-difluoromethylbenzoic acid in the form of a white solid (mass spectrometry: [M+1]=173).

The given log P values were determined in accordance with EEC directive 79/831 Annex V.A8 by HPLC (High Performance Liquid Chromatography) on a reversed-phase column (C 18). Temperature: 43° C.

Mobile phases for the determination in the acidic range (pH 2.3): 0.1% aqueous phosphoric acid, acetonitrile; linear gradient from 10% acetonitrile to 90% acetonitrile.

Calibration was carried out using unbranched alkan-2-ones (having 3 to 6 carbon atoms) with known log P values (determination of the log P values by the retention times using linear interpolation between two successive alkanones).

The lambda max values were determined in the maxima of the chromatographic signals using the UV spectra from 200 nm to 400 nm.

### Use Examples

### Example A

### Botrytis—Test (Bean)/Protective

Solvents: 24.5 parts by weight of acetone
   24.5 parts by weight of dimethylacetamide
Emulsifier: 1 part by weight of alkylaryl polyglycol ether

To produce a suitable preparation of active compound, 1 part by weight of active compound is mixed with the stated amounts of solvents and emulsifier, and the concentrate is diluted with water to the desired concentration.

To test for protective activity, young plants are sprayed with the preparation of active compound at the stated application rate. After the spray coating has dried on, two small pieces of agar colonized with Botrytis cinerea are placed onto each leaf. The inoculated plants are placed in a dark chamber at about 20° C. and 100% relative atmospheric humidity.

2 days after the inoculation, the size of the infected areas on the leaves is evaluated. 0% means an efficacy which corresponds to that of the control, whereas an efficacy of 100% means that no infection is observed.

In this test, for example, the compounds Nos. 3 and 4 of the Preparation Examples (cf Table 1) exhibit, at an application rate of 500 g/ha, an efficacy of 95% or more.

### Example B

### Puccinia Test (Wheat)/Protective

Solvent: 25 parts by weight of N,N-dimethylacetamide
Emulsifier: 0.6 part by weight of alkylaryl polyglycol ether

To produce a suitable preparation of active compound, 1 part by weight of active compound is mixed with the stated amounts of solvent and emulsifier, and the concentrate is diluted with water to the desired concentration.

To test for protective activity, young plants are sprayed with the preparation of active compound at the stated application rate. After the spray coating has dried on, the plants are sprayed with a conidia suspension of Puccinia recondita. The plants remain in an incubation cabin at 20° C. and 100% relative atmospheric humidity for 48 hours.

The plants are then placed in a greenhouse at a temperature of about 20° C. and a relative atmospheric humidity of 80% to promote the development of rust pustules.

Evaluation is carried out 10 days after the inoculation. 0% means an efficacy which corresponds to that of the control, whereas an efficacy of 100% means that no infection is observed.

In this test, for example, the compound No. 5 of the Preparation Examples (cf Table 1) exhibit, at an application rate of 500 g/ha, an efficacy of 100%.

### Example C

### Sphaerotheca Test (Cucumber)/Protective

Solvent: 49 parts by weight of N,N-dimethylacetamide
Emulsifier: 1 part by weight of alkylaryl polyglycol ether

To produce a suitable preparation of active compound, 1 part by weight of active compound is mixed with the stated amounts of solvent and emulsifier, and the concentrate is diluted with water to the desired concentration.

To test for protective activity, young cucumber plants are sprayed with the preparation of active compound at the stated application rate. 1 day after the treatment, the plants are inoculated with a spore suspension of Sphaerotheca fuliginea. The plants are then placed in a greenhouse at 70% relative atmospheric humidity and a temperature of 23° C.

Evaluation is carried out 7 days after the inoculation. 0% means an efficacy which corresponds to that of the control, whereas an efficacy of 100% means that no infection is observed.

In this test, for example, the compounds Nos. 3 and 5 of the Preparation Examples (cf Table 1) exhibit, at an application rate of 750 g/ha, an efficacy of 100%, and the compound No. 4 exhibits an efficacy of 95%.

1. Difluoromethylbenzanilides of the formula (I) 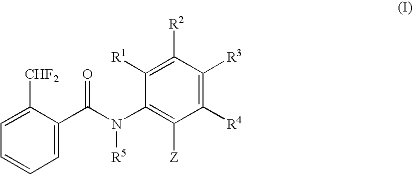
in which
R¹, R², R³ and R⁴ independently of one another represent hydrogen, fluorine, chlorine, methyl, isopropyl or methylthio,
R⁵ represents hydrogen, C₁-C₈ alkyl, C₁-C₆-alkylsulphinyl, C₁-C₆-alkylsulphonyl, C₁-C₄-alkoxy-C₁-C₄-alkyl, C₃-C₈-cycloalkyl; C₁ C₆-haloalkyl, C₁-C₄-haloalkylthio, C₁-C₄-haloalkylsulphinyl, C₁-C₄-haloalkylsulphonyl, halo-C₁-C₄-alkoxy-C₁-C₄-alkyl, C₃-C₈-halocycloalkyl having in each case 1 to 9 fluorine, chlorine and/or bromine atoms, formyl-C₁-C₃-alkyl, (C₁-C₃-alkyl)carbonyl-C₁-C₃-alkyl, (C₁-C₃-alkoxy)carbonyl-C₁-C₃-alkyl; (C₁-C₃-haloalkyl)carbonyl-C₁-C₃-alkyl, (C₁-C₃-haloalkoxy)carbonyl-C₁-3-alkyl having in each case 1 to 7 fluorine, chlorine and/or bromine atoms, (C₁-C₃-alkyl)carbonyl-C₁-C₃-haloalkyl, (C₁-C₃alkoxy)carbonyl-C₁-C₃-haloalkyl having in each case 1 to 6 fluorine, chlorine and/or bromine atoms, (C₁-C₃-haloalkyl)carbonyl-C₁-C₃-haloalkyl, (C₁-C₃-haloalkoxy)carbonyl-C₁-C₃-haloalkyl having in each case 1 to 13 fluorine, chlorine and/or bromine atoms; —COR⁶, —CONR⁷R⁸ or —CH₂NR⁹R¹⁰,
R⁶ represents hydrogen, C₁-C₈-alkyl, C₁-C₈-alkoxy, C₁-C₄-alkoxy-C₁-C₄-alkyl, C₃-C₈-cycloalkyl; C₁-C₆-haloalkyl, C₁-C₆-haloalkoxy, halo-C₁-C₄-alkoxy-C₁-C₄-alkyl, C₃-C₈-halocycloalkyl having in each case 1 to 9 fluorine, chlorine and/or bromine atoms, —COR¹¹,
R⁷ and R⁸ independently of one another represent hydrogen, C₁-C₈-alkyl, C₁-C₄-alkoxy-C₁-C₄-alkyl, C₃-C₈-cycloalkyl; C₁-C₈-haloalkyl, halo-C₁-C₄-alkoxy-C₁-C₄-alkyl, C₃-C₈-halocycloalkyl having in each case 1 to 9 fluorine, chlorine and/or bromine atoms,
R⁷ and R⁸ furthermore together with the nitrogen atom to which they are attached form a saturated heterocycle which is optionally mono- or polysubstituted by identical or different substituents from the group consisting of halogen and C₁-C₄-alkyl and which has 5 to 8 ring atoms,
where the heterocycle may contain 1 or 2 further non-adjacent heteroatoms from the group consisting of oxygen, sulphur and NR¹²,
R⁹ and R¹⁰ independently of one another represent hydrogen, C₁-C₈-alkyl, C₃-C₈-cycloalkyl; C₁-C₈-haloalkyl, C₃-C₈-halocycloalkyl having in each case 1 to 9 fluorine, chlorine and/or bromine atoms,
R⁹ and R¹⁰ furthermore together with the nitrogen atom to which they are attached form a saturated heterocycle which is optionally mono- or polysubstituted by identical or different substituents from the group consisting of halogen and C₁-C₄-alkyl and which has 5 to 8 ring atoms, where the heterocycle may contain one or two further non-adjacent heteroatoms from the group consisting of oxygen, sulphur and NR¹²,
R¹¹ represents hydrogen, C₁-C₈-alkyl, C₁-C₈-alkoxy, C₁-C₄-alkoxy-C₁-C₄-alkyl, C₃-C₈-cycloalkyl; C₁-C₆-haloalkyl, C₁-C₆-haloalkoxy, halo-C₁-C₄-alkoxy-C₁-C₄-alkyl, C₃-C₈-halocycloalkyl having in each case 1 to 9 fluorine, chlorine and/or bromine atoms,
R¹² represents hydrogen or C₁-C₆-alkyl,
Z represents Z¹, Z², Z³ or Z⁴, where
Z¹ represents phenyl which is optionally mono- to pentasubstituted by identical or different substituents,
Z² represents bicycloalkyl or cycloalkyl which is optionally mono- or polysubstituted by identical or different substituents,
Z³ represents unsubstituted C₂-C₂₀-alkyl or represents C₁-C₂₀-alkyl which is mono- or polysubstituted by identical or different substituents from the group consisting of halogen and C₃-C₆-cycloalkyl, where the cycloalkyl moiety for its part may optionally be mono- or polysubstituted by identical or different substituents from the group consisting of halogen and C₁-C₄-alkyl,
Z⁴ represents C₂-C₂₀-alkenyl or C₂-C₂₀-alkynyl, each of which is optionally mono- or polysubstituted by identical or different substituents from the group consisting of halogen and C₃-C₆-cycloalkyl, where the cycloalkyl moiety for its part may optionally be mono- or polysubstituted by identical or different substituents from the group consisting of halogen and C₁-C₄-alkyl, or
R¹, R² and R³ independently of one another represent hydrogen or fluorine and Z and R⁴ together with the carbon atoms to which they are attached form an optionally substituted 5- or 6-membered carbocyclic or heterocyclic ring.

2. Difluoromethylbenzanilides of the formula (I) according to claim 1 in which
R¹, R², R³ and R⁴ independently of one another represent hydrogen, fluorine, chlorine or methyl,
R⁵ represents hydrogen; C₁-C₆-alkyl, C₁-C₄-alkylsulphinyl, C₁-C₄-alkylsulphonyl, C₁-C₃-alkoxy-C₁-C₃-alkyl, C₃-C₆-cycloalkyl; C₁-C₄-haloalkyl, C₁-C₄-haloalkylthio, C₁-C₄-haloalkylsulphinyl, C₁-C₄-haloalkylsulphonyl, halo-C₁-C₃-alkoxy-C₁-C₃-alkyl, C₃-C₆-halocycloalkyl having in each case 1 to 9 fluorine, chlorine and/or bromine atoms, formyl-C₁-C₃-alkyl, (C₁-C₃-alkyl)carbonyl-C₁-C₃-alkyl, (C₁-C₃-alkoxy)carbonyl-C₁-C₃-alkyl; (C₁-C₃-haloalkyl)carbonyl-C₁-C₃-alkyl, (C₁-C₃-haloalkoxy)carbonyl-C₁-C₃-alkyl having in each case 1 to 7 fluorine, chlorine and/or bromine atoms, (C₁-C₃-alkyl)carbonyl-C₁-C₃-haloalkyl, (C₁-C₃-alkoxy)carbonyl-C₁-C₃-haloalkyl having in each case 1 to 6 fluorine, chlorine and/or bromine atoms, (C₁-C₃-haloalkyl)carbonyl-C₁-C₃-haloalkyl, (C₁-C₃-haloalkoxy)carbonyl-C₁-C₃-haloalkyl having in each case 1 to 13 fluorine, chlorine and/or bromine atoms; —COR⁶, —CONR⁷R⁸ or —CH₂NR⁹R¹⁰,
R⁶ represents hydrogen, C₁-C₆-alkyl, C₁-C₄-alkoxy, C₁-C₃-alkoxy-C₁-C₃-alkyl, C₃-C₆-cycloalkyl; C₁-C₄-haloalkyl, C₁-C₄-haloalkoxy, halo-C₁-C₃-alkoxy-C₁-C₃-alkyl, C₃-C₆-halocycloalkyl having in each case 1 to 9 fluorine, chlorine and/or bromine atoms, —COR¹¹,
R⁷ and R⁸ independently of one another represent hydrogen, C₁-C₆-alkyl, C₁-C₃-alkoxy-C₁-C₃-alkyl, C₃-C₆-cycloalkyl; C₁-C₄-haloalkyl, halo-C₁-C₃-alkoxy-C₁-C₃-alkyl, C₃-C₆-halocycloalkyl having in each case 1 to 9 fluorine, chlorine and/or bromine atoms,
R⁹ and R¹⁰ independently of one another represent hydrogen, C₁-C₆-alkyl, C₃-C₆-cycloalkyl; C₁-C₄-haloalkyl, C₃-C₆-halocycloalkyl having in each case 1 to 9 fluorine, chlorine and/or bromine atoms,
R¹¹ represents hydrogen, C₁-C₆-alkyl, C₁-C₄-alkoxy, C₁-C₃-alkoxy-C₁-C₃-alkyl, C₃-C₆-cycloalkyl; C₁-C₄-haloalkyl, C₁-C₄-haloalkoxy, halo-C₁-C₃-alkoxy-C₁-C₃-alkyl, C₃-C₆-halocycloalkyl having in each case 1 to 9 fluorine, chlorine and/or bromine atoms,
R¹² represents hydrogen or C₁-C₄-alkyl,
Z represents Z¹, Z², Z³ or Z⁴, in which
Z¹ represents phenyl which is optionally mono- to pentasubstituted by identical or different substituents, where the substituents are selected from the list W¹,
W¹ represents halogen, cyano, nitro, amino, hydroxyl, formyl, carboxyl, carbomoyl, thiocarbamoyl;
in each case straight-chain or branched alkyl, hydroxyalkyl, oxoalkyl, alkoxy, alkoxyalkyl, alkylthioalkyl, dialkoxyalkyl, alkylthio, alkylsulphinyl or alkylsulphonyl having in each case 1 to 8 carbon atoms;
in each case straight-chain or branched alkenyl or alkenyloxy having in each case 2 to 6 carbon atoms;
in each case straight-chain or branched haloalkyl, haloalkoxy, haloalkylthio, haloalkylsulphinyl or haloalkylsulphonyl having in each case 1 to 6 carbon atoms and 1 to 13 identical or different halogen atoms;
in each case straight-chain or branched haloalkenyl or haloalkenyloxy having in each case 2 to 6 carbon atoms and 1 to 11 identical or different halogen atoms;
in each case straight-chain or branched alkylamino, dialkylamino, alkylcarbonyl, alkylcarbonyloxy, alkoxycarbonyl, alkylaminocarbonyl, dialkylaminocarbonyl, aryl alkylaminocarbonyl, dialkylaminocarbonyloxy having 1 to 6 carbon atoms in the respective hydrocarbon chains, alkenylcarbonyl or alkynylcarbonyl having 2 to 6 carbon atoms in the respective hydrocarbon chains; cycloalkyl or cycloalkyloxy having in each case 3 to 6 carbon atoms;
in each case doubly attached alkylene having three or four carbon atoms, oxyalkylene having two or three carbon atoms or dioxyalkylene having one or two carbon atoms, each of which radicals is optionally mono- to tetrasubstituted by identical or different substituents from the group consisting of fluorine, chlorine, oxomethyl, trifluoromethyl or ethyl;
or a grouping —C(Q¹)=N-Q² in which
Q¹ represents hydrogen, hydroxyl, alkyl having 1 to 4 carbon atoms, haloalkyl having 1 to 4 carbon atoms and 1 to 9 identical or different halogen atoms or cycloalkyl having 1 to 6 carbon atoms and
Q² represents hydroxyl, amino, methylamino, phenyl, benzyl or represents in each case optionally halogen-, cyano-, hydroxyl-, -alkoxy, alkylthio-, alkylamino-, dialkylamino- or phenyl-substituted alkyl or alkoxy having 1 to 4 carbon atoms, or represents alkenyloxy or alkynyloxy having in each case 2 to 4 carbon atoms,
and also phenyl, phenoxy, phenylthio, benzoyl, benzoylethenyl, cinnamoyl, heterocyclyl or phenylalkyl, phenylalkyloxy, phenylalkylthio or heterocyclylalkyl having in each case 1 to 3 carbon atoms in the respective alkyl moieties, each of which radicals is optionally mono- to trisubstituted in the cyclic part by halogen and/or straight-chain or branched alkyl or alkoxy having 1 to 4 carbon atoms,
Z² represents cycloalkyl or bicycloalkyl having in each case 3 to 10 carbon atoms, each of which radicals is optionally mono- to tetrasubstituted by identical or different C₁-C₄-alkyl,
Z³ represents unsubstituted C₂-C₂₀-alkyl or represents C₁-C₂₀-alkyl which is mono- or polysubstituted by identical or different substituents from the group consisting of fluorine, chlorine, bromine, iodine and C₃-C₆-cycloalkyl, where the cycloalkyl moiety for its part may optionally be mono- to tetrasubstituted by identical or different substituents from the group consisting of fluorine, chlorine, bromine, iodine, C₁-C₄-alkyl and C₁-C₄-haloalkyl,
Z⁴ represents C₂-C₂₀-alkenyl or C₂-C₂₀-alkynyl, each of which is optionally mono- or polysubstituted by identical or different substituents from the group consisting of fluorine, chlorine, bromine, iodine and C₃-C₆-cycloalkyl, where the cycloalkyl moiety for its part may optionally be mono- to tetrasubstituted by identical or different substituents from the group consisting of fluorine, chlorine, bromine, iodine, C₁-C₄-alkyl and C₁-C₄-haloalkyl,
Z and R⁴ together with the carbon atoms to which they are attached may also represent a 5- or 6-membered carbocyclic or heterocyclic ring which is optionally mono- to tetrasubstituted by identical or different substituents.

3. Process for preparing the difluoromethylbenzanilides of the formula (I) according to claim 1, characterized in that
a) difluoromethylbenzoyl derivatives of the formula (II) 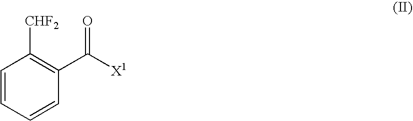
in which X¹ represents chlorine or hydroxyl, are reacted with aniline derivatives of the formula (III) 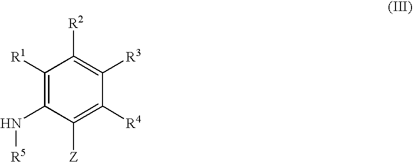
in which R¹, R², R³, R⁴, R⁵ and Z are as defined in claim 1, if appropriate in the presence of a catalyst, if appropriate in the presence of a condensing agent, if appropriate in the presence of an acid binder and if appropriate in the presence of a diluent, or
b) halodifluoromethylbenzanilides of the formula (IV) 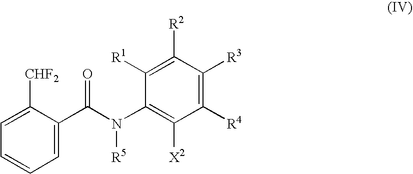
in which
R¹, R², R³, R⁴ and R⁵ are as defined in claim 1 and
X² represents chlorine, bromine, iodine or trifluoromethylsulphonate are reacted with boronic acid derivatives of the formula (V) 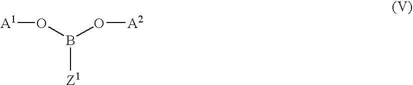
in which
Z¹ is as defined in claim 1 and
A¹ and A² each represent hydrogen or together represent tetramethylethylene,
in the presence of a catalyst, if appropriate in the presence of an acid binder and if appropriate in the presence of a diluent, or
c) difluoromethylbenzamide boronic acid derivatives of the formula (VI) 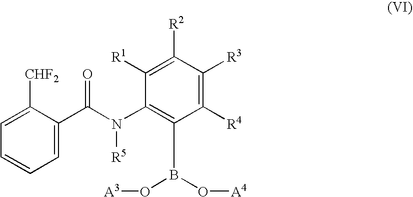
in which
R¹, R², R³, R⁴ and R⁵ are as defined in claim 1 and
A³ and A⁴ each represent hydrogen or together represent tetramethylethylene, are reacted with phenyl derivatives of the formula (VII)
X³-Z¹ (VII)
in which
Z¹ is as defined in claim 1 and
X³ represents chlorine, bromine, iodine or trifluoromethylsulphonate,
in the presence of a catalyst, if appropriate in the presence of an acid binder and if appropriate in the presence of a diluent, or
d) halodifluoromethylbenzanilides of the formula (IV) 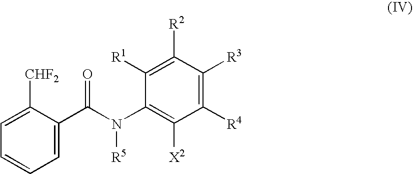
in which
R¹, R², R³, R⁴ and R⁵ are as defined in claim 1, and
X² represents chlorine, bromine, iodine or trifluoromethylsulphonate, are reacted with phenyl derivatives of the formula
X³-Z¹ (VII)
in which
Z¹ is as defined in claim 1 and
X³ represents chlorine, bromine, iodine or trifluoromethylsulphonate,
in the presence of a palladium or nickel catalyst and in the presence of 4,4,4′,4′,5,5,5′,5′-octamethyl-2,2′-bis-1,3,2-dioxaborolane, if appropriate in the presence of an acid binder and if appropriate in the presence of a diluent, or
e) difluoromethylbenzanilides of the formula (Ia) 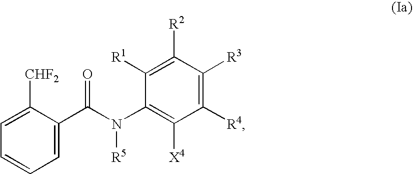
in which
R¹, R², R³, R⁴ and R⁵ are as defined in claim 1 and
X⁴ represents C₂-C₂₀-alkenyl or C₂-C₂₀-alkynyl, each of which is optionally mono- or polysubstituted by identical or different substituents from the group consisting of halogen and C₃-C₆-cycloalkyl, where the cycloalkyl moiety for its part may optionally be substituted by halogen and/or C₁-C₄-alkyl,
are hydrogenated, if appropriate in the presence of a diluent and if appropriate in the presence of a catalyst, or
f) hydroxyalkyldifluoromethylbenzanilides of the formula (VIII) 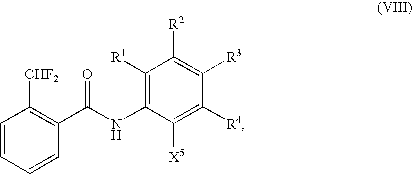
in which
R¹, R², R³, R⁴ and R⁵ are as defined in claim 1 and
X⁵ represents C₂-C₂₀-hydroxyalkyl which is optionally additionally mono- or polysubstituted by identical or different substituents from the group consisting of halogen and C₃-C₆-cycloalkyl, where the cycloalkyl moiety for its part may optionally be substituted by halogen and/or C₁-C₄-alkyl, are dehydrated, if appropriate in the presence of a diluent and if appropriate in the presence of an acid, or
g) halogen-difluoromethylbenzanilides of the formula (IV) 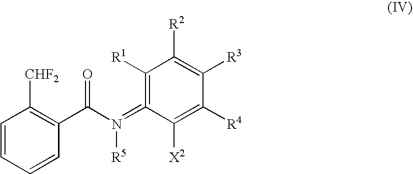
in which
R¹, R², R³, R⁴ and R⁵ are as defined in claim 1, and
X² represents chlorine, bromine, iodine or trifluoromethylsulphonate, are reacted with an alkine of the formula (IX)
HC≡-A⁵ (IX),
in which
A⁵ represents C₂-C₁₈-alkyl which is optionally mono- or polysubstituted by identical or different substituents from the group consisting of halogen and C₃-C₆-cycloalkyl, where the cycloalkyl moiety for its part may optionally be substituted by halogen and/or C₁-C₄-alkyl, or an alkene of the formula (X) 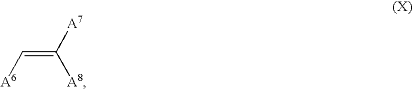
in which
A⁶, A⁷ and A⁸ independently of one another each represent hydrogen or alkyl which is optionally mono- or polysubstituted by identical or different substituents from the group consisting of halogen and C₃-C₆-cycloalkyl, where the cycloalkyl moiety for its part may optionally be substituted by halogen and/or C₁-C₄-alkyl and the total number of carbon atoms of the open-chain part of the molecule does not exceed the number 20,
if appropriate in the presence of a diluent, if appropriate in the presence of an acid binder and if appropriate in the presence of one or more catalysts, or
h) ketones of the formula (XI) 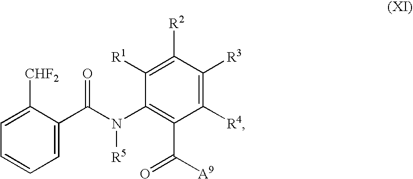
in which
R¹, R², R³, R⁴ and R⁵ are as defined in claim 1 and
A⁹ represents hydrogen or represents C₁-C₁₈-alkyl which is optionally mono- or polysubstituted by identical or different substituents from the group consisting of halogen and C₃-C₆-cycloalkyl, where the cycloalkyl moiety for its part may optionally be substituted by halogen and/or C₁-C₄-alkyl,
are reacted with a phosphorus compound of the formula (XII)
A¹⁰-Px (XII),
in which
A¹⁰ represents C₁-C₁₈-alkyl which is optionally mono- or polysubstituted by identical or different substituents from the group consisting of halogen and C₃-C₆-cycloalkyl, where the cycloalkyl moiety for its part may optionally be substituted by halogen and/or C₁-C₄-alkyl,
Px represents a grouping —P⁺(C₆H₅)₃Cl⁻, —P⁺(C₆H₅)₃Br⁻, —P⁺(C₆H₅)₃I, —P(═O) (OCH₃)₃ or —P(═O)(OC₂H₅)₃,
if appropriate in the presence of a diluent, or
i) difluoromethylbenzanilides of the formula (Ib) 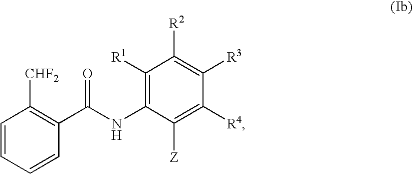
in which
R¹, R², R³, R⁴ and Z are as defined in claim 1 are reacted with a halide of the formula (XIII)
R⁵⁻¹-X⁶ (XIII)
in which
R⁵⁻¹ represents C₁-C₈-alkyl, C₁-C₆-alkylsulphinyl, C₁-C₆-alkylsulphonyl, C₁-C₄-alkoxy-C₁-C₄-alkyl, C₃-C₈-cycloalkyl; C₁-C₆-haloalkyl, C₁-C₄-haloalkylthio, C₁-C₄-haloalkylsulphinyl, C₁-C₄-haloalkylsulphonyl, halo-C₁-C₄-alkoxy-C₁-C₄-alkyl, C₃-C₈-halocycloalkyl having in each case 1 to 9 fluorine, chlorine and/or bromine atoms, formyl-C₁-C₃-alkyl, (C₁-C₃-alkyl)carbonyl-C₁-C₃-alkyl, (C₁-C₃-alkoxy)carbonyl-C₁-C₃-alkyl; (C₁-C₃-haloalkyl)carbonyl-C₁-C₃-alkyl, (C₁-C₃-haloalkoxy)carbonyl-C₁-C₃- alkyl having in each case 1 to 7 fluorine, chlorine and/or bromine atoms, (C₁-C₃ alkyl)carbonyl-C₁-C₃-haloalkyl, (C₁-C₃-alkoxy)carbonyl-C₁-C₃-haloalkyl having in each case 1 to 6 fluorine, chlorine and/or bromine atoms, (C₁-C₃-haloalkyl)carbonyl-C₁-C₃-haloalkyl, (C₁-C₃-haloalkoxy)carbonyl-C₁-C₃-haloalkyl having in each case 1 to 13 fluorine, chlorine and/or bromine atoms; —COR⁶, —CONR⁷R⁸ or —CH₂NR⁹R¹⁰,
R⁶, R⁷, R⁸, R⁹ and R¹⁰ are as defined in claim 1 and
X⁶ represents chlorine, bromine or iodine,
in the presence of a base and in the presence of a diluent.

4. Compositions for controlling unwanted microorganisms, characterized in that they comprise at least one difluoromethylbenzanilide of the formula (I) according to claim 1, in addition to extenders, surfactants or a combination of one or more extenders and surfactants.

5. (canceled)

6. Method for controlling unwanted microorganisms, characterized in that difluoromethylbenzanilides of the formula (I) according to claim 1 are applied to the microorganisms and/or their habitat.

7. A process for preparing compositions, characterized in that difluoromethylbenzanilides of the formula (I) according to claim 1 are mixed with extenders, surfactants or a combination of one or more extenders and surfactants.

8. Hydroxyalkyldifluoromethylbenzanilides of the formula (VIII) 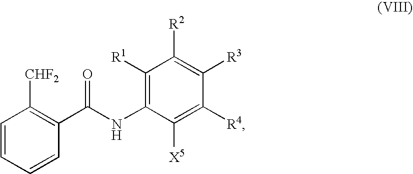
in which
R¹, R², R³, R⁴ and R⁵ are as defined in claim 1,
X⁵ represents C₂-C₂₀-hydroxyalkyl which is optionally additionally mono- or polysubstituted by identical or different substituents from the group consisting of halogen and C₃-C₆-cycloalkyl, where the cycloalkyl moiety for its part may optionally be substituted by halogen and/or C₁-C₄-alkyl.

9. Difluoromethylbenzoyl derivatives of the formula (II) 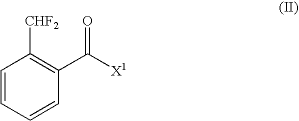
in which X¹ represents chlorine or hydroxyl.

10. Process for preparing difluormethylbenzoyl derivatives of the formula (II) according to claim 9, characterized in that 2-formylbenzonitrile of the formula (XIV) 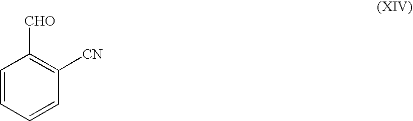
is, in a first step, fluorinated with (diethylamino)sulphur trifluoride in the presence of a diluent,
and the resulting 2-difluoromethylbenzonitrile of the formula (XV) 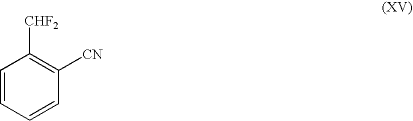
is, in a second step, reacted with a base and this acid is optionally, in a third step, reacted with a chlorinating agent in the presence of a diluent to give the corresponding acid chloride.
